(19) United States
(12) Patent Application Publication
(10) Pub. No.: US 2016/0146993 A1
(43) Pub. Date: May 26, 2016

(54) DIELECTRIC MULTILAYER COATING FILM

(71) Applicant: KONICA MINOLTA, INC., Tokyo (JP)

(72) Inventors: Takenori KUMAGAI, Hino-shi, Tokyo (JP); Taro KONUMA, Fuchu-shi, Tokyo (JP); Haruka MASUDA, Kojima-cho, Chufu-shi, Tokyo (JP)

(21) Appl. No.: 14/897,419

(22) PCT Filed: Jun. 10, 2014
(86) PCT No.: PCT/JP2014/065363

§ 371 Date: Dec. 10, 2015

(30) Foreign Application Priority Data
Jun. 14, 2013 (JP) 2013-125800

(51) Int. Cl. G02B 5/28; G02B 1/14

(52) U.S. Cl. CPC G02B 5/285; G02B 1/14; G02B 5/281; G02B 5/283

(57) ABSTRACT

An object of the present invention is to provide a dielectric multilayer coating film with high weather-resistant adhesion.

The dielectric multilayer coating film includes a dielectric multilayer coating having a stack of high and low refractive index layers; and a hard coat layer, wherein at least one of the high and low refractive index layers contains a compound with photocatalytic activity, and when the dielectric multilayer coating is divided into two halves along its thickness direction, there is a difference of 0.1% to less than 10% between the volume shrinkage of the half distal to the hard coat layer and the volume shrinkage of the hard coat layer.

### TECHNICAL FIELD

The present invention relates to a derivative multilayer coating film.

### BACKGROUND ART

In general, a dielectric multilayer coating having a stack of high and low refractive index layers each with a controlled optical thickness can selectively reflect light with a specific wavelength. This is also supported theoretically. A film having such a dielectric multilayer coating is used, for example, as a heat ray blocking film on building windows and vehicle components. Such a heat ray blocking film can transmit visible rays and selectively block near infrared rays. The reflection wavelength of such a heat ray blocking film can be controlled only by controlling the thickness and refractive index of each layer, and therefore, such a heat ray blocking film can also reflect ultraviolet or visible light.

In a method of forming a dielectric multilayer coating, layers are generally stacked by a dry process. However, such a dry process for forming a dielectric multilayer coating requires high manufacturing costs and therefore is not practical. Practical methods include a method of applying coating liquids containing a mixture of a water-soluble resin and inorganic fine particles by a wet coating process to form a laminate (see, for example, WO 2012/014607 A) and a method of stacking resin films (see, for example, JP 2008-528313 W (WO 2006/074168 A)).

### SUMMARY OF INVENTION

### Technical Problem

In the forming method described in WO 2012/014607 A, a compound with photocatalytic activity, such as titanium oxide or zirconium oxide, is used as a refractive index modifier in the high refractive index layer. Therefore, when such a dielectric multilayer coating film is exposed to the outdoors for a long term, the high refractive index layer becomes brittle due to the photocatalytic activity of the refractive index modifier. This leads to the phenomenon of delamination of the respective layers constituting the dielectric multilayer coating film, such as the high and low refractive index layers in the dielectric multilayer coating and the hard coat layer provided as the uppermost layer of the film, which means a decrease in their weather-resistant adhesion. Higher weather-resistant adhesion has been demanded of such a dielectric multilayer coating film containing a compound with photocatalytic activity.

The present invention has been accomplished in view of the above problem, and an object of the present invention is to provide means for improving the weather-resistant adhesion in a dielectric multilayer coating film containing a compound with photocatalytic activity.

In view of the above problem, the present inventors have conducted intensive studies. As a result, the present inventors have accomplished the present invention based on findings that a dielectric multilayer coating film having a dielectric multilayer coating and a hard coat layer, wherein the dielectric multilayer coating is obtained by stacking high and low refractive index layers and at least one of the high and low refractive index layers contains a compound with photocatalytic activity, can have high weather-resistant adhesion when it has the feature that when the dielectric multilayer coating is divided into two halves along its thickness direction, the difference between the volume shrinkages of the hard coat layer and the half of the dielectric multilayer coating distal to the hard coat layer falls within a specific range.

Specifically, the present invention is directed to a dielectric multilayer coating film including: a dielectric multilayer coating having a stack of high and low refractive index layers; and a hard coat layer, wherein at least one of the high and low refractive index layers contains a compound with photocatalytic activity, and when the dielectric multilayer coating is divided into two halves along its thickness direction, there is a difference of 0.1% to less than 10% between the volume shrinkage of the half distal to the hard coat layer and the volume shrinkage of the hard coat layer.

### BRIEF DESCRIPTION OF DRAWINGS

FIG. 1 is a schematic cross-sectional view showing an example of the layered structure of a derivative multilayer coating film according to the present invention, in which reference numeral 1 represents a substrate, reference numeral 2 represents a low refractive index layer, reference numeral 3 represents a high refractive index layer, reference numeral 4A represents a dielectric multilayer coating, reference numeral 5A represents an intermediate layer, and reference numeral 6A represents a hard coat layer.

FIG. 2 is a schematic cross-sectional view showing another example of the layered structure of a derivative multilayer coating film according to the present invention, in which reference numeral 1 represents a substrate, reference numeral 2 represents a low refractive index layer, reference numeral 3 represents a high refractive index layer, reference numerals 4A and 4B represent a dielectric multilayer coating, reference numerals 5A and 5B represent an intermediate layer, reference numerals 6A and 6B represent a hard coat layer, and reference numeral 10 represents the sun.

### DESCRIPTION OF EMBODIMENTS

The dielectric multilayer coating film of the present invention includes a dielectric multilayer coating and a hard coat layer, in which the dielectric multilayer coating includes high and low refractive index layers, at least one of the high and low refractive index layers contains a compound with photocatalytic activity, and when the dielectric multilayer coating is divided into two halves along its thickness direction, there is a difference of 0.1% to less than 10% between the volume shrinkage of the half distal to the hard coat layer and the volume shrinkage of the hard coat layer (hereinafter, such a difference is also simply referred to as a volume shrinkage difference).

When a dielectric multilayer coating containing a compound with photocatalytic activity is exposed to sunlight, ultraviolet light may cause the compound with photocatalytic activity to produce a catalytic effect, which may cause the phenomenon of decomposition of the surrounding resin. It has been found that when a hard coat layer is deteriorated by ultraviolet radiation, a phenomenon can occur in which the shrinkage force of the hard coat layer increases to cause delamination of the respective layers constituting the dielectric multilayer coating.

To address this problem, the dielectric multilayer coating film of the present invention has the feature that when the dielectric multilayer coating containing a compound with photocatalytic activity is divided into two halves, there is a difference of 0.1% to less than 10% between the volume shrinkage of the half distal to the hard coat layer and the volume shrinkage of the hard coat layer. This feature makes it possible to reduce the shrinkage force of the dielectric multilayer coating, even when the coating contains a compound with photocatalytic activity, and to reduce the shrinkage stress on the hard coat layer, which can improve the weather-resistant adhesion. The half of the dielectric multilayer coating distal to the hard coat layer is more likely to be degraded by ultraviolet rays. Therefore, the volume shrinkage difference between the distal half and the hard coat layer is set in the range according to the present invention so that the weather-resistant adhesion can be improved.

Hereinafter, the components of the dielectric multilayer coating film of the present invention and embodiments and modes for carrying out the present invention will be described in detail. As used hereinafter, the word to means to include the values before and after it as the lower and upper limits.

[Basic Structure of Dielectric Multilayer Coating Film]

Hereinafter, typical structures of the dielectric multilayer coating film of the present invention will be described with reference to the drawings.

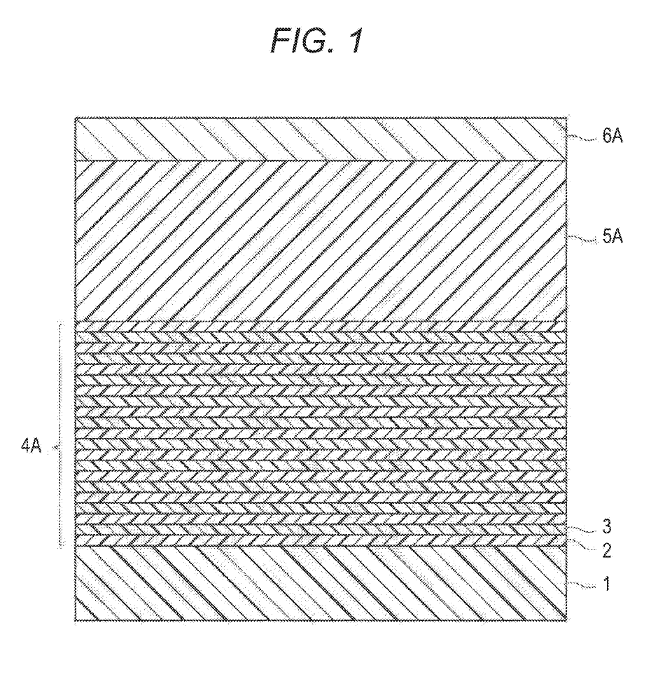

FIG. 1 is a schematic cross-sectional view showing an example of the layered structure of the dielectric multilayer coating film of the present invention.

The dielectric multilayer coating film shown in FIG. 1 includes a substrate 1 such as a transparent resin substrate, a dielectric multilayer coating 4A on the substrate 1, an intermediate layer 5A on the coating 4A, and a hard coat layer 6A as an uppermost surface layer, in which the dielectric multilayer coating 4A includes a plurality of low refractive index layers 2 and a plurality of high refractive index layers 3 alternately stacked.

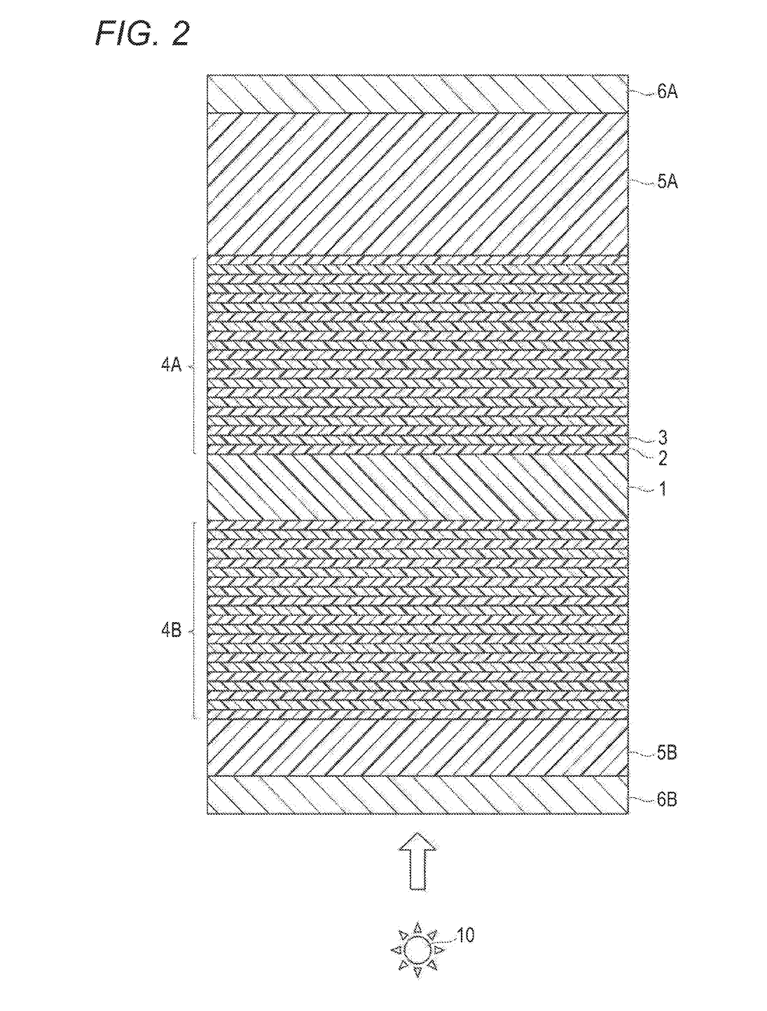

FIG. 2 is a schematic cross-sectional view showing another example of the layered structure of the dielectric multilayer coating film of the present invention.

The structure shown in FIG. 2 further includes a dielectric multilayer coating 4B, an intermediate layer 5B, and a hard coat layer 6B provided on the surface of the substrate 1 opposite to its surface on which the dielectric multilayer coating 4A, the intermediate layer 5A, and the hard coat layer 6A are provided. The hard coat layer 6B is located on the sun 10 side, for example, when the structure is placed on a window glass or the like.

The dielectric multilayer coating film of the present invention preferably has a total thickness of 40 to 315 μm, more preferably 50 to 200 μm, even more preferably 60 to 100 μm.

In order to have an additional function, the dielectric multilayer coating film of the present invention may also include at least one functional layer under the substrate or on the uppermost surface layer opposite to the substrate. Such a functional layer or layers may be one or more of a conductive layer, an antistatic layer, a gas barrier layer, an easy adhesion layer (adhesive layer), an antifouling layer, a deodorizing layer, a drip layer, a lubricating layer, a hard coat layer, a wear resistant layer, an anti-reflection layer, an electromagnetic wave shielding layer, an ultraviolet absorbing layer, an infrared absorbing layer, a printing layer, a fluorescent layer, a hologram layer, a release layer, a pressure-sensitive adhesive layer, an adhesive layer, an infrared cut layer (a metal layer or a liquid crystal layer) other than the high and low refractive index layers according to the present invention, a colored layer (a visible light absorbing layer), and an intermediate coating layer for use to form a glass laminate.

Next, each component of the dielectric multilayer coating film of the present invention will be described in detail with reference to a case where the dielectric multilayer coating film is an infrared blocking film. The dielectric multilayer coating film of the present invention may also be used as an ultraviolet blocking film. In this case, each component may be as described below, except for the high and low refractive index layers. For example, when the dielectric multilayer coating film of the present invention is for use as an ultraviolet blocking film, the high refractive index layer preferably has a thickness in the range of 10 to 500 nm, and the low refractive index layer preferably has a thickness in the range of 10 to 500 μm.

[Components of the Dielectric Multilayer Coating Film]

[1] Substrate

The derivative multilayer coating film of the present invention may include a substrate. In the present invention, the substrate is preferably a transparent resin film, which plays a role as a support in the dielectric multilayer coating film. In the present invention, the material, thickness, and other properties of the substrate are preferably so selected that the value obtained by dividing the thermal shrinkage of the dielectric multilayer coating film by the thermal shrinkage of the substrate is in the range of 1 to 3.

In the present invention, the substrate preferably has a thickness of 30 to 200 μm, more preferably 30 to 150 μm, even more preferably 35 to 125 μm. With a thickness of 30 μm or more, the substrate can resist wrinkling during handling. With a thickness of 200 μm or less, for example, the substrate can well follow the shape of a transparent substrate with a curved surface and resist wrinkling when bonded to the transparent substrate.

In the present invention, the substrate is preferably a biaxially stretched polyester film. Alternatively, the substrate may be an unstretched polyester film or a polyester film having been stretched in at least one direction. For strength improvement and thermal expansion reduction, the substrate is preferably a stretched film. A stretched film is more preferred particularly for use in car windshields.

In view of transparency, mechanical strength, and dimensional stability, the polyester is preferably composed mainly of terephthalic acid or 2,6-naphthalenedicarboxylic acid as a dicarboxylic acid component and ethylene glycol or 1,4-cyclohexanedimethanol as a diol component. Particularly preferred examples of the polyester include polyesters based on polyethylene terephthalate or polyethylene naphthalate, copolyesters of terephthalic acid, 2,6-naphthalenedicarboxylic acid, and ethylene glycol, and blends based on two or more of these polyesters.

When the dielectric multilayer coating film of the present invention includes the substrate, the dielectric multilayer coating and the hard coat layer described below should be formed on at least one surface of the substrate or may be formed on both surfaces of the substrate.

[2] Dielectric Multilayer Coating

In the present invention, the dielectric multilayer coating includes a high refractive index layer or layers and a low refractive index layer or layers. In the present invention, the dielectric multilayer coating has the function of reflecting sunlight, infrared light, visible light, or ultraviolet light, in which at least one of the high and low refractive index layers contains a compound with photocatalytic activity.

Each high refractive index layer preferably has a thickness of 20 to 800 nm, more preferably 50 to 500 nm. Each low refractive index layer preferably has a thickness of 20 to 800 nm, more preferably 50 to 500 nm.

When the thickness of each layer is measured, the high and low refractive index layers may form a clear interface between them or form a structure with continuous changes in composition. When the composition continuously changes from the interface, the position with a refractive index equal to the minimum refractive index+Δn/2 may be assumed as the interface between the two layers, wherein Δn is the difference between the maximum and minimum refractive indices in the region where the components of the respective layers mix together so that the refractive index changes continuously. This also applies to the thickness of the low refractive index layers described below.

In the present invention, the refractive index modifier profile of the dielectric multilayer coating formed by stacking the high and low refractive index layers can be observed by a process that includes etching the coating in the depth direction from the surface by sputtering at a rate of 0.5 nm/minute while measuring the atomic composition of the coating with an XPS surface analyzer, in which the uppermost surface is determined as 0 nm. Alternatively, the profile may be observed by cutting the multilayer coating and measuring the cut section for atomic composition with an XPS surface analyzer. When the concentration of the refractive index modifier discontinuously changes in the mixture region, the boundary can be identified from an electron microscope (TEM) photograph of the cut section.

The XPS surface analyzer may be of any type. For example, ESCALAB 200R manufactured by VG Scientifics may be used. The measurement may be performed at a power of 600 W (an acceleration voltage of 15 kV and an emission current of 40 mA) using Mg for the X-ray anode.

In the present invention, the total number of layers in the dielectric multilayer coating is preferably 6 to 50, more preferably 8 to 40, even more preferably 9 to 30, in view of productivity. The total number of the high and low refractive index layers is preferably 11 to 31 in view of infrared reflectance, light transmittance, and prevention of heat-induced delamination or cracking.

The dielectric multilayer coating is preferably so designed that there is a large difference between the refractive indices of the high and low refractive index layers, so that a high light reflectance can be achieved with a small number of layers. In the present invention, the difference between the refractive indices of the high and low refractive index layers adjacent to each other is preferably 0.1 or more, more preferably 0.3 or more, even more preferably 0.35 or more, further more preferably 0.4 or more. In this regard, however, the feature of the uppermost or lowermost layer may be out of the preferred range.

The reflectance in a specific wavelength region is determined by the refractive index difference between adjacent two layers and the number of stacked layers. The number of layers necessary for the same reflectance decreases as the refractive index difference increases. The refractive index difference and the number of necessary layers can be calculated using a commercially available piece of optical design software. For example, if the refractive index difference is less than 0.1, 200 or more layers must be stacked to achieve a near infrared reflectance of 90% or more, which may not only reduce productivity but also increase scattering at the interface between the stacked layers, so that the transparency may decrease and trouble-free production may be difficult. In order to improve the reflectance and reduce the number of layers, the refractive index difference has no upper limit. Virtually, however, the refractive index difference may be limited up to about 1.4.

When the dielectric multilayer coating according to the present invention includes a substrate, the lowermost layer adjacent to the substrate in the layered structure is preferably a low refractive index layer in view of the adhesion to the substrate.

In the present invention, at least one of the high and low refractive index layers constituting the dielectric multilayer coating contains a compound with photocatalytic activity. As used herein, the term “at least one of the high and low refractive index layers” means that at least one of a high refractive index layer or layers and a low refractive index layer or layers contains a compound with photocatalytic activity. In other words, the dielectric multilayer coating film of the present invention may have a high refractive index layer or layers free of the compound with photocatalytic activity and/or a low refractive index layer or layers free of the compound with photocatalytic activity as long as the compound with photocatalytic activity is present in at least one of high and low refractive index layers.

In view of the reflectance of the dielectric multilayer coating, at least one of the high refractive index layers preferably contains the compound with photocatalytic activity, and more preferably, all the high refractive index layers contain the compound with photocatalytic activity.

In the present invention, the term “a compound with photocatalytic activity” means a compound capable of producing a catalytic effect or a certain chemical change upon exposure to light. According to the present invention, the derivative multilayer coating film can have high weather-resistant adhesion due to the volume shrinkage difference in the specified range although such a compound with photocatalytic activity is present in the dielectric multilayer coating film.

Examples of the compound with photocatalytic activity include inorganic compounds and organic compounds. Examples of the inorganic compounds include metal oxide particles, which can be used as a first refractive index modifier in the high refractive index layer and as a second refractive index modifier in the low refractive index layer as described below. Examples of the organic compounds that may be used include benzoin and derivatives thereof, acetophenone, benzophenone, hydroxybenzophenone, Michler's ketone, α-amyloxime ester, thioxanthone, derivatives thereof, n-butylamine, triethylamine, tri-n-butyl phosphine, and other sensitizers. These compounds are non-limiting examples, and examples of the compound with photocatalytic activity may include all types of materials capable of producing active species such as radicals or cations upon exposure to light.

In the present invention, when the dielectric multilayer coating is divided into two halves along its thickness direction, there is a difference of 0.1% to less than 10% between the volume shrinkage of the half distal to the hard coat layer and the volume shrinkage of the hard coat layer. In the dielectric multilayer coating according the present invention, each refractive index layer is relatively thin and does not have so high a volume shrinkage. Therefore, if the volume shrinkage difference is tried to be less than 0.1%, the hard coat layer must have a low volume shrinkage. In such a case, the hard coat layer must have a reduced crosslink density and thus cannot have a desired level of scratch resistance. On the other hand, if the volume shrinkage difference is 10% or more, the weather-resistant adhesion will decrease. The volume shrinkage difference is preferably 1% to 7%, more preferably 1% to 5%.

When the dielectric multilayer coating is divided into two halves, the volume shrinkage of the half distal to the hard coat layer and the volume shrinkage of the hard coat layer may be defined as follows.

<Volume Shrinkage of Dielectric Multilayer Coating>

The volume shrinkage of the dielectric multilayer coating may be measured by the following method. The specific gravity of the resin to be contained in the high and low refractive index layers is measured according to JIS Z 8807:2012. Assuming that the density of water is 1 g/cm³, the measured value is used as the resin density (g/cm³) before curing.

The resin density after curing is determined by the following procedure. A high refractive index layer-forming coating liquid or a low refractive index layer-forming coating liquid is applied to a 50-μm-thick polyethylene terephthalate film and then dried to form a coating. The weight (g), area (cm²), and thickness (μm) of the coating are measured and then used in the calculation of the resin density (g/cm³) after curing. The volume shrinkage is calculated from the resin densities before and after curing using the following mathematical formula (1):

[Formula 1]

Volume shrinkage (%)=(the resin density before curing)/(the resin density after curing)×100 (1)

When the half of the dielectric multilayer coating distal to the hard coat layer includes only a coating obtained through the application of a high or low refractive index layer-forming coating liquid, the volume shrinkage should be determined by a process that includes applying a high refractive index layer-forming coating liquid and a low refractive index layer-forming coating liquid in an amount only enough for the number of layers in the half distal to the hard coat layer, drying the coating liquid, then measuring the weight and volume of the resulting coating by the above method, and performing the calculation.

When the half of the dielectric multilayer coating distal to the hard coat layer has a refractive index layer formed by extrusion of a resin as described below, the specific gravity of the resin used to form the refractive index layer is measured, and the measured value is used as the resin density (g/cm³) before curing, assuming that the density of water is 1 g/cm³. The weight (g), area (cm²), and thickness (μm) of the formed film are also measured and used in the calculation of the resin density. The calculated value is used as the resin density (g/cm³) after curing. The volume shrinkage is calculated from the resin densities before and after curing using mathematical formula (1) above.

When the dielectric multilayer coating is divided into two halves along its thickness direction, the boundary between the two halves sometimes is not the interface between the high and low refractive index layers but in the middle of a single high or low refractive index layer. In such a case, the layer having the boundary between the two halves should be handled as a part of the half when the volume shrinkage is calculated.

The dielectric multilayer coating may have a high refractive index layer or layers free of the compound with photocatalytic activity and/or a low refractive index layer or layers free of the compound with photocatalytic activity. In this case, a part extending, in the dielectric multilayer coating, from the layer closest to the hard coat layer to the photocatalytic layer most distal to the hard coat layer should be divided into two halves.

The dielectric multilayer coatings may be formed on both sides of the substrate, and the hard coat layer may be formed on the surfaced of only one of the dielectric multilayer coatings. In this case, only the dielectric multilayer coating on the side where the hard coat layer is formed should be divided into two halves.

Two or more hard coat layers may be provided, for example, as shown in FIG. 2. In this case, the volume shrinkage difference should be defined as the difference between the volume shrinkage of one of two halves of the derivative multilayer coating distal to the hard coat layer formed at the uppermost surface opposite to a pressure-sensitive adhesive layer and the volume shrinkage of the hard coat layer formed at the uppermost surface opposite to the pressure-sensitive adhesive layer.

<Volume Shrinkage of Hard Coat Layer>

The volume shrinkage of the hard coat layer may be determined as follows. The specific gravity of the resin is measured according to JIS Z 8807:2012. Assuming that the density of water is 1 g/cm³, the measured value is used as the resin density (g/cm³) before curing. The resin density after curing is determined by the following procedure. A hard coat layer-forming coating liquid is applied to a 50-μm-thick polyethylene terephthalate film and then irradiated with ultraviolet rays to forma coating. The weight (g), area (cm²), and thickness (μm) of the coating are measured and then used in the calculation of the resin density (g/cm³) after curing. The volume shrinkage is calculated from the resin densities before and after curing using the above formula.

When two or more hard coat layers are provided, for example, as shown in FIG. 2, the volume shrinkage of the hard coat layer formed at the uppermost surface opposite to a pressure-sensitive adhesive layer should be used.

(1) High Refractive Index Layer

In the present invention, the high refractive index layer or layers may have any composition. Preferably, the high refractive index layer includes a first water-soluble binder resin and a first refractive index modifier containing a compound with photocatalytic activity, and optionally includes a curing agent, other binder resins, a surfactant, or any of various additives.

In the present invention, the high refractive index layer preferably has a refractive index of 1.80 to 2.50, more preferably 1.90 to 2.20.

(1-1) First Water-Soluble Binder Resin

In the present invention, the first water-soluble binder resin preferably has a weight average molecular weight of 1,000 to 200,000, more preferably 3,000 to 40,000.

In the present invention, the weight average molecular weight can be measured by known methods such as static light scattering, gel permeation chromatography (GPC), and time-of-flight mass spectrometry (TOF-MASS). Specifically, in the present invention, the weight average molecular weight is measured by gel permeation chromatography, a common known method.

The content of the first water-soluble binder resin in the high refractive index layer is preferably 5 to 50% by mass, more preferably 10 to 40% by mass, based on 100% by mass of the solids in the high refractive index layer.

The first water-soluble binder resin for use in the high refractive index layer is preferably polyvinyl alcohol. The second water-soluble binder resin for use in the low refractive index layer described below is also preferably polyvinyl alcohol.

Hereinafter, therefore, polyvinyl alcohols for use in the high and low refractive index layers will be described together.

(1-1-1) Polyvinyl Alcohols

In the present invention, the high and low refractive index layers preferably contain two or more polyvinyl alcohols with different degrees of saponification. Now, for the sake of identification, the polyvinyl alcohol for use as the first water-soluble binder resin in the high refractive index layer will be called polyvinyl alcohol (A), and that for use as the second water-soluble binder resin in the low refractive index layer will be called polyvinyl alcohol (B). Each refractive index layer may contain two or more polyvinyl alcohols with different degrees of saponification or polymerization. In such a case, the polyvinyl alcohol at the highest content in each high or low refractive index layer will be called polyvinyl alcohol (A) or (B).

In the present invention, the term “degree of saponification” refers to the ratio of the number of hydroxy groups to the total number of acetyloxy groups (derived from vinyl acetate as a raw material) and hydroxy groups in the polyvinyl alcohol.

As regards the term “polyvinyl alcohol at the highest content in each refractive index layer,” polyvinyl alcohols with a saponification degree difference of 3 mol % or less are assumed to be identical when the degree of polymerization is calculated, except that polyvinyl alcohols with a low degree of polymerization of 1,000 or less are handled as different polyvinyl alcohols (not assumed to be identical even if they include polyvinyl alcohols with a saponification degree difference of 3 mol % or less). Specifically, when polyvinyl alcohols with degrees of saponification of 90 mol %, 91 mol %, and 93 mol % are contained at 10% by mass, 40% by mass, and 50% by mass, respectively, in the same layer, the three polyvinyl alcohols are assumed to be identical, and the mixture of the three polyvinyl alcohols is called polyvinyl alcohol (A) or (B). As regards the term “polyvinyl alcohols with a saponification degree difference of 3 mol % or less,” the difference 3 mol % or less may be determined with respect to any polyvinyl alcohol. For example, when the layer contains polyvinyl alcohols with degrees of saponification of 90 mol %, 91 mol %, 92 mol %, and 94 mol %, they may be assumed to be identical because all the saponification degree differences between 91 mol % polyvinyl alcohol and other polyvinyl alcohols fall within 3 mol %.

When polyvinyl alcohols with a saponification degree difference of more than 3 mol % are contained in the same layer, they are assumed to form a mixture of different polyvinyl alcohols, and each degree of polymerization and each degree of saponification are calculated for the mixture. For example, when 5% by mass of PVA203, 25% by mass of PVA117, 10% by mass of PVA217, 10% by mass of PVA220, 10% by mass of PVA224, 20% by mass of PVA235, and 20% by mass of PVA245 are present, the mixture of PVA217, PVA220, PVA224, PVA235, and PVA245 (PVA217 to PVA245 with a saponification degree difference of at most 3 mol % are assumed to be identical) is assumed to be at the highest content and called polyvinyl alcohol (A) or (B). Thus, the degree of polymerization of the mixture of PVA217 to PVA245 is calculated as (1,700×0.1+2,000×0.1+2,400×0.1+3,500×0.2+4, 500×0.7)/0.7=3,200, and the degree of saponification of the mixture is calculated to be 88 mol %.

The absolute value of the difference between the degrees of saponification of polyvinyl alcohols (A) and (B) is preferably 3 mol % or more, more preferably 5 mol % or more. Preferably, in such a range, a good mixed state can be formed between the high and low refractive index layers. The saponification degree difference between polyvinyl alcohols (A) and (B) is preferably as large as possible. In view of the solubility of polyvinyl alcohol in water, however, the difference is preferably 20 mol % or less.

In view of solubility in water, polyvinyl alcohols (A) and (B) preferably have a degree of saponification of 75 mol % or more. More preferably, one of polyvinyl alcohols (A) and (B) has a degree of saponification of 90 mol % or more and the other has a degree of saponification of 90 mol % or less so that a good mixed state can be formed between the high and low refractive index layers. Even more preferably, one of polyvinyl alcohols (A) and (B) has a degree of saponification of 95 mol % or more and the other had a degree of saponification of 90 mol % or less. The upper limit of the degree of saponification of polyvinyl alcohols is generally, but not limited to, less than 100 mol % or about 99.9 mol % or less.

When two polyvinyl alcohols with different degrees of saponification are used, they preferably have a degree of polymerization of 1,000 or more, more preferably 1, 500 to 5,000, even more preferably 2,000 to 5,000. This is because when the degree of polymerization of the polyvinyl alcohols is 1,000 or more, the resulting coating can be prevented from cracking and when it is 5,000 or less, a stable coating liquid can be formed. As used herein, the term “a stable coating liquid” means a coating liquid capable of being stable over time. Preferably, at least one of polyvinyl alcohols (A) and (B) has a degree of polymerization in the range of 2,000 to 5,000, which makes it possible to reduce the cracking of the resulting coating and improve the reflectance at a specific wavelength. More preferably, both polyvinyl alcohols (A) and (B) have a degree of polymerization of 2,000 to 5,000, so that the above effect can be more significant.

In the present invention, the term “degree of polymerization” refers to viscosity average degree of polymerization. The degree of polymerization can be determined according to JIS K 6726 (1994) by a process that includes completely re-saponifying PVA, purifying the saponified PVA, measuring its intrinsic viscosity [η] (dl/g) in water at 30° C., and calculating the degree of polymerization from the following mathematical formula (2).

[Formula 2]

P=([η]×10³/8.29)^{(1/0.62)} (2)

Polyvinyl alcohol (B) in the low refractive index layer preferably has a degree of saponification in the range of 75 to 90 mol % and a degree of polymerization in the range of 2,000 to 5,000. The addition of polyvinyl alcohol with such properties to the low refractive index layer is advantageous in that interface mixing can be reduced more effectively. This may be because the resulting coating resists cracking and has improved setting properties.

Polyvinyl alcohols (A) and (B) for use in the present invention may be synthesized or obtained commercially. Examples of commercially available products that may be used as polyvinyl alcohols (A) and (B) include PVA-102, PVA-103, PVA-105, PVA-110, PVA-117, PVA-120, PVA-124, PVA-203, PVA-205, PVA-210, PVA-217, PVA-220, PVA-224, and PVA-235 (each manufactured by KURARAY CO., LTD.) and JC-25, JC-33, JF-03, JF-04, JF-05, JP-03, JP-04, JP-05, and JP-45 (each manufactured by JAPAN VAM & POVAL CO., LTD.).

In the present invention, the water-soluble binder resin may contain a modified polyvinyl alcohol, which is obtained by partially modifying polyvinyl alcohol, in addition to normal polyvinyl alcohol obtained by hydrolysis of polyvinyl acetate, as long as the effects of the present invention are not impaired. The addition of such a modified polyvinyl alcohol can improve the adhesion, water resistance, or flexibility of the coating. Such a modified polyvinyl alcohol may be a cationic modified polyvinyl alcohol, an anionic modified polyvinyl alcohol, a nonionic modified polyvinyl alcohol, or a vinyl alcohol polymer.

The cationic modified polyvinyl alcohol is, for example, a polyvinyl alcohol having a primary, secondary, or tertiary amino group or a quaternary ammonium group in the main or side chain of the polyvinyl alcohol as described in JP 61-10483 A, which can be obtained by saponifying a copolymer of a cationic group-containing ethylenically unsaturated monomer and vinyl acetate.

Examples of the anionic modified polyvinyl alcohol include a polyvinyl alcohol having an anionic group as described in JP 01-206088 A, a copolymer of vinyl alcohol and a water-soluble group-containing vinyl compound as described in JP 61-237681 A and JP 63-307979 A, and a modified polyvinyl alcohol having a water-soluble group as described in JP 07-285265 A.

Examples of the nonionic modified polyvinyl alcohol include a polyvinyl alcohol derivative having a polyalkylene oxide group added to part of polyvinyl alcohol as described in JP 07-9758 A, a block copolymer of a hydrophobic group-containing vinyl compound and vinyl alcohol as described in JP 08-25795 A, a silanol-modified polyvinyl alcohol having a silanol group, and a reactive group-modified polyvinyl alcohol having a reactive group such as an acetoacetyl, carbonyl, or carboxy group.

A polyvinyl alcohol-based water-soluble polymer is also preferably used, such as Exceval (registered trademark) manufactured by KURARAY CO., LTD. or Nichigo G-Polymer (registered trademark) manufactured by Nippon Synthetic Chemical industry Co., Ltd.

Two or more modified polyvinyl alcohols with different degrees of polymerization or of different modification types may be used in combination.

The content of the modified polyvinyl alcohol is preferably, but not limited to, 1 to 30% by mass based on the total mass (on a solid basis) of each refractive index layer. In such a range, the above effects can be produced more effectively.

In the present invention, two polyvinyl alcohols with different degrees of saponification are preferably used in layers with different refractive indices, respectively.

For example, polyvinyl alcohol (A) with a low degree of saponification may be used in the high refractive index layer, and polyvinyl alcohol (B) with a high degree of saponification may be used in the low refractive index layer. In this case, the content of polyvinyl alcohol (A) in the high refractive index layer is preferably in the range of 40% by mass to 100% by mass, more preferably 60% by mass to 95% by mass, based on the total mass of all polyvinyl alcohols in the layer, and the content of polyvinyl alcohol (B) in the low refractive index layer is preferably in the range of 40% by mass to 100% by mass, more preferably 60% by mass to 95% by mass, based on the total mass of all polyvinyl alcohols in the low refractive index layer. Alternatively, polyvinyl alcohol (A) with a high degree of saponification may be used in the high refractive index layer, and polyvinyl alcohol (B) with a low degree of saponification may be used in the low refractive index layer. In this case, the content of polyvinyl alcohol (A) in the high refractive index layer is preferably in the range of 40% by mass to 100% by mass, more preferably 60% by mass to 95% by mass, based on the total mass of all polyvinyl alcohols in the layer, and the content of polyvinyl alcohol (B) in the low refractive index layer is preferably in the range of 40% by mass to 100% by mass, more preferably 60% by mass to 95% by mass, based on the total mass of all polyvinyl alcohols in the low refractive index layer. When the content is 40% by mass or more, the effect of suppressing interlayer mixing and reducing interface disturbance can be significantly produced. On the other hand, when the content is 100% by mass or less, the coating liquid can have improved stability.

(1-1-2) Other Binder Resins

In the present invention, any additional resin other than polyvinyl alcohol may be used as the first water-soluble binder resin in the high refractive index layer, as long as it can form a coating as the high refractive index layer containing the first refractive index modifier. Similarly, any additional resin other than polyvinyl alcohol may also be used as the second water-soluble binder resin in the low refractive index layer described below, as long as it can form a coating as the low refractive index layer containing the second refractive index modifier. Preferably, in view of environmental problems and coating flexibility, resins other than polyvinyl alcohol are preferably water-soluble polymers (specifically, gelatin, thickening polysaccharides, and reactive functional group-containing polymers). Such water-soluble polymers may be used alone or in a mixture of two or more.

In the high refractive index layer, the additional resin may be used in an amount of 5 to 50% by mass, based on 100% by mass of the solids in the high refractive index layer, in combination with polyvinyl alcohol, which is preferably used as the first water-soluble binder resin.

In the present invention, the binder resin is preferably composed of a water-soluble polymer or polymers, so that there is no need to use any organic solvent, which is preferred for environmental preservation. Specifically, in the present invention, a water-soluble polymer or polymers other than polyvinyl alcohol and modified polyvinyl alcohol may be used as the binder resin in addition to the polyvinyl alcohol and the modified polyvinyl alcohol as long as the effects of the present invention are not impaired. The term “water-soluble polymer” refers to such a polymer that when it is dissolved at a concentration of 0.5% by mass in water at the most soluble temperature, the mass of the insoluble matter separated by filtration with a G2 glass filter (maximum pore size 40 to 50 μm) will be 50% or less of the mass thereof added. Among such water-soluble polymers, gelatin, celluloses, thickening polysaccharides, or reactive group-containing polymers are particularly preferred. These water-soluble polymers may be used alone or in a mixture of two or more. Examples of such water-soluble polymers include, for example, compounds described in paragraphs [0033] to [0041] of JP 2013-007817 A.

(1-2) First Refractive Index Modifier

In the present invention, the first refractive index modifier suitable for use in the high refractive index layer may be an inorganic material or an organic material. In general, an inorganic material is preferred because it has a higher refractive index, and metal oxide particles with a refractive index of 2.0 to 3.0 are more preferred. Metal oxide particles for use as the first refractive index modifier can serve as the compound with photocatalytic activity.

More specifically, examples include titanium oxide, zirconium oxide, zinc oxide, synthetic amorphous silica, colloidal silica, alumina, colloidal alumina, lead titanate, red lead, chrome yellow, zinc yellow, chromium oxide, ferric oxide, iron black, copper oxide, magnesium oxide, magnesium hydroxide, strontium titanate, yttrium oxide, niobium oxide, europium oxide, lanthanum oxide, zircon, and tin oxide. Complex oxide particles including different metals or core-shell particles in which a metal or metals form a core-shell structure may also be used. Organic materials may also be used, such as thiophene compounds, polyphenylene sulfide compounds, polyacetylene compounds, polyphenylene vinylene compounds, polypyrrole compounds, and polyaniline compounds.

In the present invention, particles of an oxide of a high refractive index metal such as titanium or zirconium, specifically, titanium oxide particles and/or zirconia oxide particles are preferably added to the high refractive index layer so that the resulting layer can be transparent and have a higher refractive index. Among them, titanium oxide particles are more preferred in view of the stability of the coating liquid for forming the high refractive index layer. Specifically, rutile-type titanium oxide (tetragonal system) is more preferable than anatase-type titanium oxide because the former has lower catalytic activity, which makes it possible to improve the weather resistance of the high refractive index layer or the adjacent layer and to increase the refractive index.

When core-shell particles are used as the first refractive index modifier in the high refractive index layer according to the present invention, silicon-containing hydrous oxide in the shell layer can interact with the first water-soluble binder resin so that interlayer mixing between the high refractive index layer and the adjacent layer can be effectively suppressed. For this effect, core-shell particles including titanium oxide particles coated (surface-treated) with silicon-containing hydrous oxide are more preferred.

In the present invention, an aqueous solution containing titanium oxide particles may be used to form the core of the core-shell particles. Such an aqueous solution preferably has a pH of 1.0 to 3.0, and the titanium oxide particles to be used are preferably prepared by hydrophobilizing the surface of particles in an aqueous titanium oxide sol, where the titanium oxide particles have a positive zeta potential, so that the titanium oxide particles can be dispersed in an organic solvent.

In the present invention, the content of the metal oxide particles used as the first refractive index modifier is preferably 15 to 80% by mass base on 100% by mass of the solids in the high refractive index layer, so that a certain refractive index difference can be made between the high and lower refractive index layers. The content of the metal oxide particles is more preferably 20 to 77% by mass, even more preferably 30 to 75% by mass. The content of metal oxide particles other than the core-shell particles in the high refractive index layer according to the present invention may be at any level as long as the effects of the present invention can be produced.

In the present invention, the metal oxide particles used as the first refractive index modifier preferably have a volume average particle size of 50 nm or less, more preferably 1 to 40 nm. The metal oxide particles with a volume average particle size of 50 nm or less are preferred because they can provide a low haze and high visible light transparency.

In the present invention, the volume average particle size of the metal oxide particles used as the first refractive index modifier may be determined as follows. The sizes of any 1,000 particles are measured by a method of observing the particles themselves by using laser diffraction scattering, dynamic light scattering, or an electron microscope or by a method of observing, with an electron microscope, the section of the refractive index layer or particle images appearing on the surface. The volume average particle size is calculated as the volume-weighted average particle size expressed by the formula: volume average particle size mv={Σ(vi·di)}/{Σ(vi)}, wherein vi is the volume per particle, based on the observed population of metal oxide particles, in which d1-, d2-, . . . , di-, . . . , and dk-sized particles are present in numbers of n1, n2, . . . , ni, . . . , and nk, respectively.

(1-3) Curing Agent

In the present invention, a curing agent may also be used to cure the first water-soluble binder resin used in the high refractive index layer. The curing agent for use with the first water-soluble binder resin may be of any type capable of undergoing a curing reaction with the first water-soluble binder resin. For example, when polyvinyl alcohol is used as the first water-soluble binder resin, the curing agent is preferably any of boric acid and a salt thereof. Besides boric acid and a salt thereof, other known curing agents may also be used. Such other known curing agents are generally compounds having a group capable of reacting with polyvinyl alcohol or compounds capable of promoting the reaction between different groups of polyvinyl alcohol, which may be appropriately selected and used. Examples of such curing agents other than boric acid and a salt thereof include epoxy curing agents (such as diglycidyl ethyl ether, ethylene glycol diglycidyl ether, 1,4-butanediol diglycidyl ether, 1,6-diglycidylcyclohexane, N,N-diglycidyl-4-glycidyloxyaniline, sorbitol polyglycidyl ether, and glycerol polyglycidyl ether), aldehyde curing agents (such as formaldehyde and glyoxal), active halogen curing agents (such as 2,4-dichloro-4-hydroxy-1,3,5-s-triazine), active vinyl compounds (such as 1,3,5-trisacryloyl-hexahydro-s-triazine and bisvinylsulfonylmethyl ether), and aluminum alum.

The term “boric acid and a salt thereof” refers to an oxyacid with boron as a central atom and a salt thereof, examples of which include orthoboric acid, diboric acid, metaboric acid, tetraboric acid, pentaboric acid, octaboric acid, and salts thereof.

(2) Low Refractive Index Layer

In the present invention, the low refractive index layer may include a second water-soluble binder resin and a second refractive index modifier and may further include a curing agent, a surface coating component, a particle surface protecting agent, other binder resins, and any of various additives such as a surfactant.

In the present invention, the low refractive index layer preferably has a refractive index of 1.10 to 1.60, more preferably 1.30 to 1.50.

(2-1) Second Water-Soluble Binder Resin

In the present invention, the second water-soluble binder resin for use in the low refractive index layer is preferably polyvinyl alcohol. More preferably, polyvinyl alcohol (B) with a degree of saponification different from that of polyvinyl alcohol (A) in the high refractive index layer is preferably used in the low refractive index layer according to the present invention. The preferred weight average molecular weight and other properties of the second water-soluble binder resin and polyvinyl alcohols (A) and (B) are described above for the first water-soluble binder resin in the high refractive index layer. Therefore, a duplicate description thereof will be omitted herein.

The content of the second water-soluble binder resin in the low refractive index layer is preferably 20 to 99.9% by mass, more preferably 25 to 80% by mass, based on 100% by mass of the solids in the low refractive index layer.

<Other Water-Soluble Binder Resin>

In the present invention, any additional resin other than polyvinyl alcohol may be used as the second water-soluble binder resin in the low refractive index layer, as long as it can form a coating as the low refractive index layer containing a refractive index modifier. Preferably, in view of environmental problems and coating flexibility, resins other than polyvinyl alcohol are preferably water-soluble polymers (specifically, gelatin, thickening polysaccharides, and reactive functional group-containing polymers). Such water-soluble polymers may be used alone or in a mixture of two or more.

In the low refractive index layer, the additional resin may be used in an amount of 0.1 to 10% by mass, based on 100% by mass of the solids in the low refractive index layer, in combination with polyvinyl alcohol, which is preferably used as the second water-soluble binder resin.

In the present invention, the low refractive index layer may also contain any of water-soluble polymers such as celluloses, thickening polysaccharides, and reactive group-containing polymers. Such celluloses, thickening polysaccharides, reactive group-containing polymers, and other water-soluble polymers may be the same as those described above for the high refractive index layer. Therefore, a duplicate description thereof will be omitted herein.

(2-2) Second Refractive Index Modifier

In the present invention, the second refractive index modifier suitable for use in the low refractive index layer may be an inorganic material or an organic material. Preferably, in view of compatibility with the second water-soluble binder resin, liquid stability, and cost, silica (silicon dioxide) is preferably used as the second refractive index modifier. Examples of silica include synthetic amorphous silica and colloidal silica. Among them, acidic colloidal silica is more preferably used, and a colloidal silica sol dispersed in an organic solvent is even more preferably used. In order to further reduce the refractive index, hollow fine particles, which have hollow interiors, may be used as the second refractive index modifier for the low refractive index layer. Hollow fine particles of silica (silicon dioxide) are particularly preferred. When metal oxide particles are used as the second refractive index modifier, the metal oxide particles can serve as a compound with photocatalytic activity.

When used as the second refractive index modifier for the low refractive index layer, the metal oxide particles (preferably silicon dioxide) preferably have an average particle size of 3 to 100 nm. When dispersed in the form of primary particles, silicon dioxide particles preferably have an average particle size (the size of particles in a dispersion before application) of 3 to 50 nm, more preferably 3 to 40 nm, even more preferably 3 to 20 nm, further more preferably 4 to 10 nm. On the other hand, secondary particles preferably have an average particle size of 30 nm or less, so that low haze and high visible light transparency can be achieved.

The average particle size of the metal oxide particles used as the second refractive index modifier in the low refractive index layer can be determined as the simple average (number average) of the measured sizes of any 1,000 particles, which are observed directly with an electron microscope or observed on the cross-section or surface of the refractive index layer with an electron microscope. In this case, the size of each particle is defined as the diameter of a virtual circle with the same area as its projection.

Colloidal silica for use as the second refractive index modifier can be obtained by metathesis of sodium silicate with an acid or the like or by heating and aging silica sol obtained through an ion exchange resin layer, for example, as described in JP 57-14091 A, JP 60-219083 A, JP 60-219084 A, JP 61-20792 A, JP 61-188183 A, JP 63-17807 A, JP 04-93284 A, JP 05-278324 A, JP 06-92011 A, JP 06-183134 A, JP 06-297830 A, JP 07-81214 A, JP 07-101142 A, JP 07-179029 A, JP 07-137431 A, and WO 94/26530 A.

Such colloidal silica may be synthesized or obtained commercially. The colloidal silica may have a cation-modified surface or have undergone a treatment with Al, Ca, Mg, or Ba.

Hollow particles may also be used as the second refractive index modifier in the low refractive index layer. Hollow particles for use as the second refractive index modifier preferably have an average pore size of 3 to 70 nm, more preferably 5 to 50 nm, even more preferably 5 to 45 nm. In this regard, the average pore size of hollow particles is the average of the inner diameters of the hollower particles. In the present invention, when the average pore size of the hollow particles falls within the above ranges, the low refractive index layer can a sufficiently low refractive index. The average pore size can be determined by a process that includes observing, with an electron microscope, randomly selected 50 or more pores, which can be observed as circles, ellipses, or substantially circular or elliptical shapes, determining the pore diameter of each particle, and calculating the number average of the pore diameters. In this regard, the average pore size means the minimum among the distances between all possible pairs of two parallel lines between which the surrounding edge of pores are sandwiched, wherein the pores can be observed as circles, ellipses, or substantially circular or elliptical shapes.

The surface of the second refractive index modifier for use in the low refractive index layer may be coated with a surface coating material.

The content of the second refractive index modifier in the low refractive index layer is preferably 0.1 to 70% by mass, more preferably 30 to 70% by mass, even more preferably 45 to 65% by mass, based on 100% by mass of the solids in the low refractive index layer.

(2-3) Curing Agent

In the present invention, the low refractive index layer may further contain a curing agent like the high refractive index layer. The curing agent may be of any type capable of undergoing a curing reaction with the second water-soluble binder resin in the low refractive index layer. Particularly when polyvinyl alcohol is used as the second water-soluble binder resin in the low refractive index layer, the curing agent is preferably boric acid, a salt thereof, or borax. Known curing agents other than boric acid and salts thereof may also be used.

The content of the curing agent in the low refractive index layer is preferably 1 to 10% by mass, more preferably 2 to 6% by mass, based on 100% by mass of the solids in the low refractive index layer.

Specifically, when polyvinyl alcohol is used as the second water-soluble binder resin, the curing agent is preferably used in a total amount of 1 to 600 mg per 1 g of polyvinyl alcohol, more preferably 100 to 600 mg per 1 g of polyvinyl alcohol.

Examples and other features of the curing agent may be the same as those described above in the high refractive index layer section. Therefore, a duplicate description thereof will be omitted herein.

(3) Additive for Each Refractive Index Layer

In the present invention, if necessary, the high and low refractive index layers may contain any of various additives. The content of the additive in the high refractive index layer is preferably 0.005 to 20% by mass based on 100% by mass of the solids in the high refractive index layer. Hereinafter, examples of the additive will be described.

(3-1) Surfactant

In the present invention, at least one of the high and low refractive index layers may further contain a surfactant. The surfactant may be any of amphoteric, cationic, anionic, and nonionic surfactants. More preferably, the surfactant is a betaine amphoteric surfactant, a quaternary ammonium cationic surfactant, a dialkyl sulfosuccinate anionic surfactant, an acetylene glycol nonionic surfactant, or a fluorochemical cationic surfactant.

In the present invention, the content of the surfactant is preferably in the range of 0.005 to 0.30% by mass, more preferably 0.01 to 0.10% by mass, based on the total mass (100% by mass) of the high or low refractive index layer-forming coating liquid.

(3-2) Other Additives

In the present invention, the high or low refractive index layer may contain an additional additive, which is appropriately selected from an amino acid, an emulsion resin, a lithium compound, and other additives. Examples of the additional additive further include ultraviolet absorbers such as those described in JP 57-74193 A, JP 57-87988 A, and JP 62-261476 A, anti-fading agents such as those described in JP 57-74192 A, JP 57-87989 A, JP 60-72785 A, JP 61-146591 A, JP 01-95091 A, and JP 03-13376 A, fluorescent brightening agents such as those described in JP 59-42993 A, JP 59-52689 A, JP 62-280069 A, JP 61-242871 A, and JP 04-219266 A, pH adjusters such as sulfuric acid, phosphoric acid, acetic acid, citric acid, sodium hydroxide, potassium hydroxide, and potassium carbonate, antifoam agents, lubricants such as diethylene glycol, antiseptic agents, antifungal agents, antistatic agents, matting agents, heat stabilizers, antioxidants, flame retardants, crystal nucleating agents, inorganic particles, organic particles, viscosity reducers, lubricating agents, infrared absorbers, colorants, pigments, and other known various additives.

(4) Method of Forming the Dielectric Multilayer Coating

A non-limiting method of forming the dielectric multilayer coating according to the present invention preferably includes the step of applying a high refractive index layer-forming coating liquid and a low refractive index layer-forming coating liquid to a substrate (transparent resin film), wherein the high refractive index layer-forming coating liquid contains the first water-soluble binder resin and the first refractive index modifier, and the low refractive index layer-forming coating liquid contains the second water-soluble binder resin and the second refractive index modifier.

The method of application may be any wet coating method such as roller coating, rod bar coating, air knife coating, spray coating, slide curtain coating, slide hopper coating such as that descried in U.S. Pat. No. 2,761,419 or U.S. Pat. No. 2,761,791, or extrusion coating. The method of overlaying a plurality of layers may be sequential multilayer coating or simultaneous multilayer coating.

Hereinafter, simultaneous multilayer coating by slide hopper coating will be described in detail as a preferred process (coating method) in the present invention.

(4-1) Solvent

A solvent is used to form the high refractive index layer-forming coating liquid and the low refractive index layer-forming coating liquid. Such a solvent is preferably, but not limited to, water, an organic solvent, or a mixed solvent of water and an organic solvent.

Examples of the organic solvent include alcohols such as methanol, ethanol, 2-propanol, and 1-butanol; esters such as ethyl acetate, butyl acetate, propylene glycol monomethyl ether acetate, and propylene glycol monoethyl ether acetate; ethers such as diethyl ether, propylene glycol monomethyl ether, and ethylene glycol monoethyl ether; amides such as dimethylformamide and N-methylpyrrolidone; and ketones such as acetone, methyl ethyl ketone, acetyl acetone, and cyclohexanone. These organic solvents may be used alone or in a mixture of two or more.

In view of environmental awareness and easy handling, water or a mixed solvent of water and methanol, ethanol, or ethyl acetate is particularly preferred as the solvent for the coating liquid.

(4-2) Concentration of Coating Liquid

The concentration of the first water-soluble binder resin in the high refractive index layer-forming coating liquid is preferably in the range of 1 to 10% by mass. The concentration of the first refractive index modifier (metal oxide particles) in the high refractive index layer-forming coating liquid is preferably in the range of 1 to 50% by mass.

The concentration of the second water-soluble binder resin in the low refractive index layer-forming coating liquid is preferably in the range of 1 to 10% by mass. The concentration of the second refractive index modifier (metal oxide particles) in the low refractive index layer-forming coating liquid is preferably in the range of 1 to 50% by mass.

(4-3) Method of Preparing the Coating Liquid

A non-limiting method of preparing the high refractive index layer-forming coating liquid and the low refractive index layer-forming coating liquid includes, for example, adding the water-soluble binder resin, the refractive index modifier, and optionally additional additives and mixing and stirring them. In this process, the water-soluble binder resin, the refractive index modifier, and the optional additives may be added in any order. The respective components may be sequentially added and mixed with stirring, or all the components may be added at a time and mixed with stirring. If necessary a solvent is further used to adjust the viscosity to a suitable level.

In the present invention, the high refractive index layer is preferably formed using a high refractive index layer-forming aqueous coating liquid that is prepared by adding and dispersing core-shell particles. In the preparation of the high refractive index layer-forming coating liquid, the core-shell particles are preferably added in the form of a sol having a pH in the range of 5.0 to 7.5 and containing particles with a negative zeta potential.

(4-4) Viscosity of Coating Liquid

In the process of performing simultaneous multilayer coating by slid hopper coating, the high refractive index layer-forming coating liquid and the low refractive index layer-forming coating liquid preferably have a viscosity of 5 to 300 mPa·s, more preferably 10 to 250 mPa·s, at 40 to 45° C. In the process of performing simultaneous multilayer coating by slid curtain coating, the high refractive index layer-forming coating liquid and the low refractive index layer-forming coating liquid preferably have a viscosity of 5 to 1,200 mPa·s, more preferably 25 to 500 mPa·s, at 40 to 45° C.

At 15° C., the high refractive index layer-forming coating liquid and the low refractive index layer-forming coating liquid preferably have a viscosity of 10 mPa·s or more, more preferably 15 to 30,000 mPa·s, even more preferably 20 to 20,000 mPa·s, further more preferably 20 to 18,000 mPa·s.

(4-5) Coating and Drying Method

As a non-limiting example, the coating and drying method preferably includes heating the high refractive index layer-forming coating liquid and the low refractive index layer-forming coating liquid at 30° C. or higher, applying the heated high refractive index layer-forming coating liquid and the heated low refractive index layer-forming coating liquid to the substrate (transparent resin film) by simultaneous multilayer coating, then temporarily cooling (setting) the resulting coating preferably to 1 to 15° C., and then drying the coating at 10° C. or higher. The drying conditions more preferably include a wet-bulb temperature of 5 to 50° C. and a coating surface temperature of 10 to 50° C. Immediately after the application, the cooling is preferably performed under horizontal setting conditions in order to improve the uniformity of the resulting coating.

The high refractive index layer-forming coating liquid and the low refractive index layer-forming coating liquid are preferably applied in such a thickness that the desired thickness can be achieved after the drying.

As used herein, the term “setting” means a step of increasing the viscosity of the coating composition and reducing the fluidity of the material between and in the respective layers by a certain method such as blowing cold air or the like on the coating. The state of completion of setting is defined as the state in which nothing sticks to fingers when the fingers are pressed against the coating with cold air being blown on the surface of the coating.

After the application, the time (setting time) from the start of blowing cold air to the completion of setting is preferably 5 minutes or less. The lower limit of the setting time is preferably, but not limited to, 45 seconds or more. If the setting time is too short, the components in the layer may be insufficiently mixed. On the other hand, if the setting time is too long, the interlayer diffusion of the refractive index modifier may proceed, so that the refractive index difference between the high and low refractive index layers may be insufficient. The setting step may be omitted if high elasticity is quickly established between the high and low refractive index layers.

The setting time can be controlled by controlling the concentration of the water-soluble binder resin and the concentration of the refractive index modifier (the compound with photocatalytic activity) and by adding an additional material such as any of various known gelling agents including gelatin, pectin, agar, carrageenan, and gellan gum.

The temperature of the cold air is preferably 0 to 25° C., more preferably 5 to 10° C. The time for which the coating is exposed to the cold air is preferably 10 to 120 seconds, although it depends on the coating feed rate.

The dielectric multilayer coating film of the present invention may have a high refractive index layer or layers free of the compound with photocatalytic activity and/or a low refractive index layer or layers free of the compound with photocatalytic activity as long as at least one of the high and low refractive index layers contain the compound with photocatalytic activity. Such a refractive index layer free of the compound with photocatalytic activity may be, for example, a refractive index layer formed by extruding a resin.

A method of forming a refractive index layer by extruding a resin may include, for example, melting a resin, extruding the molten resin through a multilayer extrusion die onto a casting drum, and then subjecting the product to rapid cooling. In this process, after the molten resin is extruded and cooled, the resulting resin sheet may be stretched. The stretch ratio of the resin is preferably 2 to 10 times in each of the longitudinal direction and the transverse direction although it may be appropriately selected depending on the resin.

The resin may be any thermoplastic resin such as polyalkylene resin, polyester resin, polycarbonate resin, (meth)acrylic resin, amide resin, silicone resin, or fluororesin.

Examples of the polyalkylene resin include polyethylene (PE) and polypropylene (PP).

The polyester resin may be a polyester resin composed mainly of a dicarboxylic acid component and a diol component. Specifically, the polyester resin is preferably polyethylene terephthalate (PET), polybutylene terephthalate (PBT), poly-1,4-cyclohexanedimethylene terephthalate, or polyethylene naphthalate (PEN).

The polycarbonate resin may be a product of reaction between a bisphenol such as bisphenol A or a derivative thereof and phosgene or phenyl dicarbonate.

The (meth)acrylic resin may be a homopolymer or copolymer of acrylic acid, methacrylic acid, acrylonitrile, methacrylonitrile, methyl(meth)acrylate, ethyl(meth)acrylate, butyl(meth)acrylate, 2-ethylhexyl(meth)acrylate, cyclohexyl(meth)acrylate, benzyl(meth)acrylate, hydroxyethyl(meth)acrylate, 2-methoxyethyl(meth)acrylate, 2-ethoxyethyl(meth)acrylate, 2-butoxyethyl(meth)acrylate, (meth)acrylamide, N-methyl(meth)acrylamide, N-ethyl(meth)acrylamide, N,N-dimethyl(meth)acrylamide, N,N-diethyl(meth)acrylamide, N-isopropyl(meth)acrylamide, or N-tert-octyl(meth)acrylamide.

The amide resin may be an aliphatic amide resin such as 6,6-nylon, 6-nylon, 11-nylon, 12-nylon, 4,6-nylon, 6,10-nylon, or 6,12-nylon; or an aromatic polyamide derived from an aromatic diamine such as phenylene diamine and an aromatic dicarboxylic acid or a derivative thereof, such as terephthaloyl chloride or isophthaloyl chloride.

The silicone resin may be a resin having a siloxane bond as a constituting unit to which an organic group such as an alkyl group or an aromatic group is attached. Examples of the silicone resin include dimethylpolysiloxane, methylphenylpolysiloxane, diphenylpolysiloxane, and modifications thereof.

The fluororesin may be a homopolymer or copolymer of tetrafluoroethylene, hexafluoropropylene, chlorotrifluoroethylene, vinylidene fluoride, vinyl fluoride, or perfluoroalkyl vinyl ether.

The above resins may be used alone or in a mixture of two or more.

When the refractive index layers are formed by extruding resins, PET-PEN is a preferred combination of materials for the high refractive index layer and the low refractive index layer.

[3] Hard Coat Layer

The dielectric multilayer coating film of the present invention has a hard coat layer as a surface protective layer for improving scratch resistance.

In the present invention, the hard coat layer may be formed at only one surface or both surfaces of the dielectric multilayer coating film of the present invention. Some types of derivative laminate coating films can have poor adhesion to adhesive layers, or some dielectric multilayer coatings can be formed to look cloudy. However, these problems can be solved by forming the hard coat layer. In addition, the elongation of the substrate can be controlled by forming the hard coat layer.

In the present invention, the hard coat material used to form the hard coat layer is preferably an inorganic material typified by a polysiloxane material, a curable resin such as an ultraviolet-curable urethane acrylate resin, or other curable materials that can form products with low shrinkage stress after curing. These hard coat materials may be used alone or in a mixture of two or more.

(3.1) Polysiloxane Hard Coat Material

In the present invention, a polysiloxane hard coat material can be used to form the hard coat layer. The polysiloxane hard coat material is preferably a compound of general formula (1) below.

[Chemical Formula 1]

General Formula 1

(R)ₘSi(OR₁)ₘ (1)

In general formula (1), R and R₁ are each independently a linear, branched, or cyclic alkyl group of 1 to 10 carbon atoms, and m and n are each an integer satisfying the relation m+n=4.

Examples of the compound include tetramethoxysilane, tetraethoxysilane, tetraisopropoxysilane, tetra-n-propoxysilane, tetra-n-butoxysilane, tetra-sec-butoxysilane, tetra-tert-butoxysilane, tetrapentaethoxysilane, tetrapentaisopropoxysilane, tetrapenta-n-propoxysilane, tetrapenta-n-butoxysilane, tetrapenta-sec-butoxysilane, tetrapenta-tert-butoxysilane, methyltriethoxysilane, methyltripropoxysilane, methyltributoxysilane, dimethyldimethoxysilane, dimethyldiethoxysilane, dimethylethoxysilane, dimethylmethoxysilane, dimethylpropoxysilane, dimethylbutoxysilane, dimethyldimethoxysilane, dimethyldiethoxysilane, and hexyltrimethoxysilane. Examples further include γ-(2-aminoethyl)aminopropyltrimethoxysilane, γ-(2-aminoethyl)aminopropylmethyldimethoxysilane, β-(3,4-epoxycyclohexyl)ethyltrimethoxysilane, N-β-(N-aminobenzylaminoethyl)-γ-aminopropylmethoxysilane hydrochloride, γ-glycidoxypropyltrimethoxysilane, aminosilane, methylmethoxysilane, vinyltriacetoxysilane, γ-mercaptopropyltrimethoxysilane, γ-chloropropyltrimethoxysilane, hexamethyldisilazane, vinyltris(β-methoxyethoxy)silane, and octadecyldimethyl[3-(trimethoxysilyl)propyl]ammonium chloride. Compounds derived from these compounds by replacing their hydrolyzable group such as a methoxy or ethoxy group with a hydroxy group are generally called polyorganosiloxane hard coat materials.

Examples of the polyorganosiloxane hard coat material that may be used include SARCoat series and BP-16N (all manufactured by DOKEN CO., LTD.), SR2441 (manufactured by Dow Corning Toray Co., Ltd.), and Perma-New 6000 (manufactured by California Hardcoating Company).

In the present invention, a curable resin may be used to form the hard coat layer. The curable resin may be a thermosetting resin or an active energy ray-curable resin. The active energy ray-curable resin is preferred because of its easy moldability. These curable resins may be used alone or in a mixture of two or more.

(3.2) Active Energy Ray-Curable Resin

The active energy ray-curable resin is also preferably used as the hard coat material. The active energy ray-curable resin is a resin capable of being cured through a crosslinking reaction or the like when it is irradiated with active energy rays such as ultraviolet rays or electron beams. The active energy ray-curable resin preferably includes an ethylenically unsaturated double bond-containing monomer component, which can be cured to form an active energy ray-cured resin layer, namely, a hard coat layer when irradiated with active energy rays such as ultraviolet rays or electron beams. The active energy ray-curable resin is typically an ultraviolet-curable resin or an electron beam-curable resin. The ultraviolet-curable resin is preferred, which can be cured by ultraviolet irradiation.

The ultraviolet-curable resin is preferably, for example, an ultraviolet-curable urethane acrylate resin, an ultraviolet-curable polyester acrylate resin, an ultraviolet-curable epoxy acrylate resin, an ultraviolet-curable polyol acrylate resin, an ultraviolet-curable acrylic acrylate resin, or an ultraviolet-curable epoxy resin. In general, the ultraviolet-curable urethane acrylate resin can be easily obtained by allowing a polyester polyol to react with an isocyanate monomer or prepolymer and then allowing the resulting product to react with a hydroxyl group-containing acrylate monomer such as 2-hydroxyethyl acrylate, 2-hydroxyethyl methacrylate (hereinafter, only “acrylate” will be shown assuming that “acrylate” also encompasses “methacrylate”), or 2-hydroxypropyl acrylate. For example, as described in JP 59-151110 A, a mixture of 100 parts by mass of UNIDIC (registered trademark) 17-806 (manufactured by DIC Corporation) and 1 part by mass of CORONATE (registered trademark) L (manufactured by Nippon Polyurethane Industry Co., Ltd.) is preferably used. In general, the ultraviolet-curable polyester acrylate resin can be easily obtained by allowing the hydroxyl or carboxyl terminal group of polyester to react with a monomer such as 2-hydroxyethyl acrylate, glycidyl acrylate, or acrylic acid (see, for example, JP 59-151112 A). The ultraviolet-curable epoxy acrylate resin can be obtained by allowing the hydroxyl terminal group of an epoxy resin to react with a monomer such as acrylic acid, acrylic acid chloride, or glycidyl acrylate. The ultraviolet-curable polyol acrylate resin may be, for example, a resin obtained by curing one or more of ethylene glycol(meth)acrylate, polyethylene glycol di(meth)acrylate, glycerin tri(meth)acrylate, trimethylolpropane triacrylate, pentaerythritol triacrylate, pentaerythritol tetraacrylate, dipentaerythritol pentaacrylate, dipentaerythritol hexaacrylate, alkyl-modified dipentaerythritol pentaacrylate, pentaerythritol ethylene oxide-modified tetraacrylate, and other monomers.

Besides the above, examples of commercially available active energy ray-curable resins that may be used to form the hard coat layer includes HITALOID (registered trademark) series (manufactured by Hitachi Chemical Company, Ltd.), SHIKO series (manufactured by The Nippon Synthetic Chemical Industry Co., Ltd.), and ETERMER 2382 (manufactured by Eternal Chemical Co., Ltd.).

As described above, the volume shrinkage difference is set in the specified range according to the present invention. Therefore, it is important to reduce the shrinkage stress on the hard coat layer. The method of controlling the volume shrinkage difference may be a method of appropriately selecting materials such as those listed above as raw material monomers and resins for the hard coat layer or a method of controlling the number of functional groups to be crosslinked and uncrosslinked in the above materials or controlling the molecular weight or other properties of the above materials. The monomer used as a raw material for the hard coat layer may have any structure as long as the final volume shrinkage can fall within the range according to the present invention. The monomer preferably has 2 or 20 functional groups capable of undergoing crosslinking and preferably has a molecular weight of 50 to 3,000.

The hard coat layer preferably has such properties that its shrinkage is not promoted even upon exposure to sunlight. Therefore, the hard coat layer preferably contains an ultraviolet absorber and/or an antioxidant. The content of the ultraviolet absorber and the antioxidant is preferably 0.05% by mass to 4% by mass, more preferably 0.1% by mass to 3% by mass, based on the total mass of the hard coat layer. In this regard, when the hard coat layer is exposed to ultraviolet rays, a reaction can proceed in the hard coat layer so that shrinkage stress can increase. In addition, the resin in the hard coat layer can be decomposed so that a phenomenon may occur in which the hard coat layer itself becomes brittle. Therefore, the addition of the ultraviolet absorber and the antioxidant to the hard coat layer makes it possible to suppress the shrinkage or decomposition of the hard coat layer and thus to improve the weather-resistant adhesion.

<Ultraviolet Absorber>

The ultraviolet absorber may be of a benzophenone type, a benzotriazole type, a phenyl salicylate type, or a triazine type.

Examples of benzophenone type ultraviolet absorbers include 2,4-dihydroxy-benzophenone, 2-hydroxy-4-methoxy-benzophenone, 2-hydroxy-4-n-octoxy-benzophenone, 2-hydroxy-4-dodecyloxy-benzophenone, 2-hydroxy-4-octadecyloxy-benzophenone, 2,2′-dihydroxy-4-methoxy-benzophenone, 2,2′-dihydroxy-4,4′-dimethoxy-benzophenone, and 2,2′,4,4′-tetrahydroxy-benzophenone.

Examples of benzotriazole type ultraviolet absorbers include 2-(2′-hydroxy-5-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, and 2-[2-hydroxy-3,5-bis(α,α-dimethylbenzyl)phenyl]-2H-benzotriazole.

Examples of phenyl salicylate type ultraviolet absorbers include phenyl salicylate and 2,4-di-tert-butylphenyl-3,5-di-tert-butyl-4-hydroxybenzoate. Examples of hindered amine type ultraviolet absorbers include bis(2,2,6,6-tetramethylpiperidin-4-yl)sebacate.

Examples of triazine type ultraviolet absorbers include 2,4-diphenyl-6-(2-hydroxy-4-methoxyphenyl)-1,3,5-triazine, 2,4-diphenyl-6-(2-hydroxy-4-ethoxyphenyl)-1,3,5-triazine, 2,4-diphenyl-(2-hydroxy-4-propoxyphenyl)-1,3,5-triazine, 2,4-diphenyl-(2-hydroxy-4-butoxyphenyl)-1,3,5-triazine, 2,4-diphenyl-6-(2-hydroxy-4-butoxyphenyl)-1,3,5-triazine, 2,4-diphenyl-6-(2-hydroxy-4-hexyloxyphenyl)-1,3,5-triazine, 2,4-diphenyl-6-(2-hydroxy-4-octyloxyphenyl)-1,3,5-triazine, 2,4-diphenyl-6-(2-hydroxy-4-dodecyloxyphenyl)-1,3,5-triazin e, and 2,4-diphenyl-6-(2-hydroxy-4-benzyloxyphenyl)-1,3,5-triazine.

Besides the above, ultraviolet absorbers also include compounds that have the function of converting the energy of ultraviolet rays to intramolecular vibrational energy and releasing the intramolecular vibrational energy in the form of thermal energy or the like. The ultraviolet absorber may be a compound capable of being effective when it is used in combination with an antioxidant, a colorant, or the like, or may also be used in combination with a light stabilizer called a quencher that can act as a light energy converter.

These ultraviolet absorbers may be used alone or in a mixture of two or more. The ultraviolet absorber may be synthesized or obtained commercially. Examples of commercially available products include Tinuvin (registered trademark) 320, Tinuvin (registered trademark) 328, Tinuvin (registered trademark) 234, Tinuvin (registered trademark) 1577, and Tinuvin (registered trademark) 622 (all manufactured by BASF Japan Ltd.), ADK STAB LA-31 (manufactured by ADEKA CORPORATION), and SEESORB (registered trademark) 102, SEESORB (registered trademark) 103, and SEESORB (registered trademark) 501 (all manufactured by SHIPRO KASEI KAISHA, LTD.).

<Antioxidant>

The antioxidant may be a phenolic antioxidant, a thiol antioxidant, a phosphite antioxidant, or a hindered amine antioxidant.

Examples of the phenolic antioxidant include 1,1,3-tris(2-methyl-4-hydroxy-5-tert-butylphenyl)butane, 2,2′-methylenebis(4-ethyl-6-tert-butylphenol), tetrakis-[methylene-3-(3′,5′-di-tert-butyl-4′-hydroxyphenyl)propionate]methane, 2,6-di-tert-butyl-p-cresol, 4,4′-thiobis(3-methyl-6-tert-butylphenol), 4,4′-butylidenebis(3-methyl-6-tert-butylphenol), 1,3,5-tris(3′,5′-di-tert-butyl-4′-hydroxybenzyl)-S-triazin-2,4,6-(1H,3H,5H)trione, stearyl-β-(3,5-di-tert-butyl-4-hydroxyphenyl)propionate, triethylene glycol bis[3-(3-tert-butyl-5-methyl-4-hydroxyphenyl)propionate], 3,9-bis[1,1-dimethyl-2-[β-(3-tert-butyl-4-hydroxy-5-methylphenyl)propionyloxy]ethyl]-2,4,8,10-tetraoxaspiro[5,5]-undecane, and 1,3,5-trimethyl-2,4,6-tris(3,5-di-tert-butyl-4-hydroxybenzyl)benzene. In particular, phenolic antioxidants preferably have a molecular weight of 550 or more.

Examples of the thiol antioxidant include distearyl-3.3′-thiodipropionate and pentaerythritol-tetrakis-(β-lauryl-thiopropionate).

Examples of the phosphite antioxidant include tris(2,4-di-tert-butylphenyl)phosphite, distearylpentaerythritol diphosphite, di(2,6-di-tert-butylphenyl)pentaerythritol diphosphite, bis(2,6-di-tert-butyl-4-methylphenyl)pentaerythritol diphosphite, tetrakis(2,4-di-tert-butylphenyl)-4,4′-diphenylene-diphosphonite, and 2,2′-methylenebis(4,6-di-tert-butylphenyl)octylphosphite.

Examples of the hindered amine antioxidant include bis(2,2,6,6-tetramethyl-4-piperidyl)sebacate, bis(1,2,2,6,6-pentamethyl-4-piperidyl)sebacate, tetrakis(1,2,2,6,6-pentamethyl-4-piperidyl)-1,2,3,4-butanetetracarboxylate, bis(1,2,2,6,6-pentamethyl-4-piperidyl)-2-(3,5-di-tert-butyl-4-hydroxybenzyl)-2-n-butyl malonate, 1-methyl-8-(1,2,2,6,6-pentamethyl-4-piperidyl)sebacate, 1-[2-[3-(3,5-di-tert-butyl-4-hydroxyphenyl)propionyloxy]ethyl]-4-[3-(3,5-di-tert-butyl-4-hydroxyphenyl)propionyloxy]-2,2,6,6-tetramethylpiperidine, 4-benzoyloxy-2,2,6,6-tetramethylpiperidine, tetrakis(2,2,6,6-tetramethyl-4-piperidyl)-1,2,3,4-butane-tetracarboxylate, triethylenediamine, and 8-acetyl-3-dodecyl-7,7,9,9-tetramethyl-1,3,8-triazaspiro[4,5]decane-2,4-dione.

As another example, a nickel-based ultraviolet stabilizer may also be used, such as [2,2′-thiobis(4-tert-octylphenolate)]-2-ethylhexylamine nickel(II), nickel complex-3,5-di-tert-butyl-4-hydroxybenzylphosphoric acid monoethylate, or nickel dibutyl-dithiocarbamate.

In particular, the hindered amine antioxidant is preferably a hindered amine light stabilizer containing only a tertiary amine, such as bis(1,2,2,6,6-pentamethyl-4-piperidyl)sebacate, bis(1,2,2,6,6-pentamethyl-4-piperidyl)-2-(3,5-di-tert-butyl-4-hydroxybenzyl)-2-n-butyl malonate, tetrakis(1,2,2,6,6-pentamethyl-4-piperidyl)-1,2,3,4-butanetetracarboxylate, or a condensation product of 1,2,2,6,6-pentamethyl-4-piperidinol/tridecyl alcohol and 1,2,3,4-butanetetracarboxylic acid.

These antioxidants may be used alone or in a mixture of two or more. The antioxidant may be synthesized or obtained commercially. Examples of the commercially available product include NOCRAC (registered trademark) 200, NOCRAC (registered trademark) M-17, NOCRAC (registered trademark) SP, NOCRAC (registered trademark) SP-N, NOCRAC (registered trademark) NS-5, NOCRAC (registered trademark) NS-6, NOCRAC (registered trademark) NS-30, NOCRAC (registered trademark) 300, NOCRAC (registered trademark) NS-7, and NOCRAC (registered trademark) DAH (all manufactured by OUCHI SHINKO CHEMICAL INDUSTRIAL CO., LTD.), ADK STAB AO-30, ADK STAB AO-40, ADK STAB AO-50, ADK STAB AO-60, ADK STAB AO-616, ADK STAB AO-635, ADK STAB AO-658, ADK STAB AO-80, ADK STAB AO-15, ADK STAB AO-18, ADK STAB 328, ADK STAB AO-37, ADK STAB LA-52, ADK STAB LA-57, ADK STAB LA-62, ADK STAB LA-67, ADK STAB LA-63, ADK STAB LA-68, ADK STAB LA-82, and ADK STAB LA-87 (all manufactured by ADEKA CORPORATION), IRGANOX (registered trademark) 245, IRGANOX (registered trademark) 259, IRGANOX (registered trademark) 565, IRGANOX (registered trademark) 1010, IRGANOX (registered trademark) 1024, IRGANOX (registered trademark) 1035, IRGANOX (registered trademark) 1076, IRGANOX (registered trademark) 1081, IRGANOX (registered trademark) 1098, IRGANOX (registered trademark) 1222, IRGANOX (registered trademark) 1330, IRGANOX (registered trademark) 1425WL, IRGAFOS (registered trademark) 38, IRGAFOS (registered trademark) 168, and IRGAFOS (registered trademark) P-EPQ (all manufactured by Ciba Specialty Chemicals Inc.), and Sumilizer (registered trademark) GM and Sumilizer (registered trademark) GA-80 (all manufactured by Sumitomo Chemical Co., Ltd.)

(3.2) Infrared Absorber

When the derivative multilayer coating film of the present invention is an infrared blocking film, the hard coat layer preferably contains an infrared absorber so that it can also function as an infrared absorbing layer. In the present invention, the infrared absorber for use in the hard coat layer may be any of an inorganic infrared absorber and an organic infrared absorber. An inorganic infrared absorber is preferred. In view of visible light transmittance, infrared absorbing properties, and dispersibility in resin, a zinc oxide-based infrared absorber is more preferably mixed into the hard coat layer.

Examples of the inorganic infrared absorber that may be used include zinc oxide, antimony-doped zinc oxide (AZO), indium-doped zinc oxide (IZO), gallium-doped zinc oxide (GZO), aluminum-doped zinc oxide, tin oxide, antimony-doped tin oxide (ATO), indium-doped tin oxide (ITO), zinc antimonate, lanthanum boride, and nickel complex compounds. Particularly preferred is antimony-doped zinc oxide, antimony-doped tin oxide, indium-doped tin oxide, or zinc antimonate. Examples of the organic infrared absorber that may be used include immonium compounds, phthalocyanine compounds, and aminium compounds. These infrared absorbers may be used alone or in a mixture of two or more.

The infrared absorber may be synthesized or obtained commercially. Examples of the commercially available product include zinc oxide-based products such as CELNAX (registered trademark) series (manufactured by Nissan Chemical Industries, Ltd.) and PAZET series (manufactured by HakusuiTech Co., Ltd.) and tin oxide-based products such as ATO Dispersion and ITO Dispersion (all manufactured by Mitsubishi Materials Corporation) and KH series (manufactured by Sumitomo Metal Mining Co., Ltd.). Examples of commercially available organic infrared absorbers include NIR-IM1 and NIR-AM1 (all manufactured by Nagase ChemteX Corporation) and Lumogen (registered trademark) series (manufactured by BASF).

The content of the infrared absorber in the hard coat layer is preferably 55% by mass to 80% by mass based on the total mass of the hard coat layer. Preferably, within this range, the content of the resin component in the hard coat layer is relatively low, so that the shrinkage stress can be reduced. If the content of the infrared absorber is less than 55% by mass, the hard coat layer can be relatively thick, which may tend to increase the shrinkage stress and to reduce the weather resistance. On the other hand, if the content is more than 80% by mass, the resin content can be too low with an excess of particles, so that the hard coat layer may fail to have the necessary hardness.

The hard coat layer may also contain inorganic fine particles other than the infrared absorber. Such inorganic fine particles are preferably fine parties of an inorganic compound containing a metal such as titanium, silica, zirconium, aluminum, magnesium, antimony, zinc, or tin. In order to ensure transparency to visible light, the inorganic fine particles preferably have an average particle size of 1,000 nm or less, more preferably 10 to 500 nm. The inorganic fine particles can be prevented from dropping off from the hard coat layer if there is high bonding strength between the inorganic particles and the cured resin of the hard coat layer. Therefore, the inorganic fine particles preferably have a photo-reactive group with photopolymerization reactivity, such as a monofunctional or polyfunctional acrylate, which can be introduced on their surface.

A dye or pigment may also be added to the hard coat layer so that its color can be controlled. Examples of pigments and dyes that can be preferably used include colored inorganic pigments such as cadmium red, molybdenum red, chromium vermilion, chromium oxide, viridian, titanium cobalt green, cobalt green, cobalt chromium green, Victoria green, ultramarine, ultramarine blue, Prussian blue, Berlin blue, milori blue, cobalt blue, cerulean blue, cobalt silica blue, cobalt zinc blue, manganese violet, mineral violet, and cobalt violet, organic pigments such as phthalocyanine pigments, and anthraquinone dyes.

The hard coat layer preferably has a thickness of 0.1 to 50 μm, more preferably 1 to 20 μm. The hard coat layer with a thickness of 0.1 μm or more tends to have higher hard coating properties. On the other hand, the hard coat layer with a thickness of 50 μm or less tends to allow the derivative multilayer coating film to have higher transparency.

The hard coat layer can be formed by a method of applying a coating liquid by wire bar coating, spin coating, dip coating, or the like to form a film. The hard coat layer can also be formed by a method of forming a film by a dry process such as vapor deposition. A continuous coater such as a die coater, a gravure coater, or a comma coater may also be used for the coating and the film formation. For example, a polysiloxane hard coat material is preferably heat-treated at a temperature in the range of 50 to 150° C. for 30 minutes to several days in order to facilitate the curing and crosslinking of the hard coat material, after the application and the removal of the solvent by drying. The hard coat material is preferably treated at a temperature in the range of 40 to 80° C. for at least two days taking into account the heat resistance of the coated substrate or the stability of the substrate in the form of a multilayer roll. When the active energy ray-curable resin is used, the reactivity of the resin varies with the irradiation wavelength, the irradiance, and the quantity of the active energy rays, and therefore, optimum conditions cannot be simply determined and should be selected depending on the resin to be used. For example, however, when an ultraviolet lamp is used as an active energy ray source, its irradiance is preferably 50 to 1,500 mW/cm², and the exposure dose is preferably 50 to 1,500 mJ/cm².

A surfactant may be added to the coating liquid for use in forming the hard coat layer. The surfactant can impart leveling properties, water repellency, lubricity, or the like. The surfactant may be of any type, such as an acrylic surfactant, a silicone surfactant, or a fluorochemical surfactant. Particularly in view of leveling properties, water repellency, and lubricity, a fluorochemical surfactant is preferably used. Examples of the fluorochemical surfactant that may be used include commercially available products such as Megafac (registered trademark) F series (such as F-430, F-477, F-552 to F-559, F-561, and F-562) manufactured by DIC Corporation, Megafac (registered trademark) RS series (such as RS-76-E) manufactured by DIC Corporation, SURFLON (registered trademark) series manufactured by AGC SEIMI CHEMICAL CO., LTD., POLYFOX series manufactured by OMNOVA Solutions Inc., ZX series from T&K TOKA Corporation, and OPTOOL series manufactured by Daikin Industries, Ltd.

The derivative multilayer coating film of the present invention may have a single hard coat layer or two or more hard coat layers. Two or more hard coat layers may have the same or different compositions.

[4] Intermediate Layer

The derivative multilayer coating film of the present invention may further include an intermediate layer between the derivative multilayer coating and the hard coat layer described above. The intermediate layer is formed to function to increase the adhesion between the dielectric multilayer coating and the hard coat layer and to relax the shrinkage stress on the hard coat layer. The intermediate layer preferably includes a resin component such as a polyvinyl acetal resin, an acrylic resin, or a polyurethane resin. These resin components may be used alone or in a mixture of two or more.

Hereinafter, typical examples of the resin suitable for use in the intermediate layer will be described.

(Polyvinyl Acetal Resin)

In the present invention, a polyvinyl acetal resin suitable for use in the intermediate layer is a resin obtained by acetalization reaction of polyvinyl alcohol with at least one suitable aldehyde. Examples of such a polyvinyl acetal resin include polyvinyl acetal, polyvinyl formal, polyvinyl butyral, partially-formalized polyvinyl butyral, and acetal copolymers such as polyvinyl butyral acetal.

These polyvinyl acetal resins are commercially available, such as DENKA BUTYRAL #2000L, #3000-1, #3000-K, #4000-1, #5000-A, and #6000-C, DENKA FORMAL #20, #100, and #200, manufactured by Denka Company Limited, S-LEC (registered trademark) B series (such as BL-1, BL-2, BL-S, BM-1, BM-2, BH-1, BX-1, BX-10, BL-1, BL-SH, and BX-L), S-LEC (registered trademark) K series (such as KS-10), S-LEC (registered trademark) KW series (such as KW-1, KW-3, and KW-10), and S-LEC (registered trademark) KX series (such as KX-1 and KX-5) manufactured by Sekisui Chemical Co., Ltd. These polyvinyl acetal resins may further contain other repeating units.

These polyvinyl acetal resins preferably have a degree of acetalization of 5 to 65 mol %, more preferably 15 to 50 mol % in view of solubility in water and adhesion effect. When the degree of acetalization is in the above range, the intermediate layer can have good adhesion to the hard coat layer and the dielectric multilayer coating.

<Acrylic Resin>

In the present invention, an acrylic resin suitable for use in the intermediate layer is a resin including a polymer component derived from an acrylic monomer such as methacrylic acid, acrylic acid, an ester or salt of methacrylic or acrylic acid, acrylamide, or methacrylamide. Examples of the acrylic monomer include acrylic acid; methacrylic acid; acrylic esters such as alkyl acrylates (e.g., methyl acrylate, ethyl acrylate, n-propyl acrylate, isopropyl acrylate, n-butyl acrylate, isobutyl acrylate, tert-butyl acrylate, 2-ethylhexyl acrylate, cyclohexyl acrylate, phenyl acrylate, benzyl acrylate, and phenylethyl acrylate), and hydroxy-containing alkyl acrylates (e.g., 2-hydroxyethyl acrylate and 2-hydroxypropylacrylate); methacrylic esters such as alkyl methacrylates (e.g., methyl methacrylate, ethyl methacrylate, n-propyl methacrylate, isopropyl methacrylate, n-butyl methacrylate, isobutyl methacrylate, tert-butyl methacrylate, 2-ethylhexyl methacrylate, cyclohexyl methacrylate, phenyl methacrylate, benzyl methacrylate, and phenylethyl methacrylate), and hydroxy-containing alkyl methacrylates (e.g., 2-hydroxyethyl methacrylate and 2-hydroxypropyl methacrylate); acrylamide; substituted acrylamides such as N-methylacrylamide, N-methylolacrylamide, N,N-dimethylolacrylamide, and N-methoxymethylacrylamide; methacrylamide; substituted methacrylamides such as N-methylmethacrylamide, N-methylolmethacrylamide, N,N-dimethylolmethacrylamide, and N-methoxymethylmethacrylamide; amino-substituted alkyl acrylates such as N,N-diethylaminoethyl acrylate; amino-substituted alkyl methacrylates such as N,N-diethylamino methacrylate; epoxy group-containing acrylates such as glycidyl acrylate; epoxy group-containing methacrylates such as glycidylmethacrylate; acrylic acid salts such as sodium, potassium, and ammonium salts; and methacrylic acid salts such as sodium, potassium, and ammonium salts. These acrylic monomers may be used alone or in combination of two or more. Preferred examples of the acrylic resin include methyl methacrylate-ethyl acrylate-ammonium acrylate-acrylamide copolymers and methacrylamide-butyl acrylate-sodium acrylate-methyl methacrylate-N-methylolacrylamide copolymers. The acrylic resin can be produced or is available in the form of an acrylic emulsion, an acrylic aqueous solution, or an acrylic dispersion.

In the present invention, the acrylic resin for use in the intermediate layer may be synthesized or obtained commercially. Examples of the commercially available product include LR1730 (manufactured by MITSUBISHI RAYON CO., LTD.).

An isocyanate compound may also be used as a crosslinking agent. Preferred examples of the isocyanate compound include cyclic diisocyanates such as xylylene diisocyanate, isophorone diisocyanate, and alicyclic diisocyanates, aromatic diisocyanates such as tolylene diisocyanate and 4,4-diphenylmethane diisocyanate, and aliphatic diisocyanates such as hexamethylene diisocyanate. When an aqueous system is used, a blocked isocyanate may also be used, such as BI 214 from Baxenden Chemicals, Ltd.

<Polyurethane Resin>

Polyurethane resin is a generic name for polymers having a urethane bond in their main chain, which are generally obtained by the reaction between a polyisocyanate and a polyol. Examples of the polyisocyanate include tolylene diisocyanate (TDI), diphenylmethane diisocyanate (MDI), naphthylene diisocyanate (NDI), toluidine diisocyanate (TODI), hexamethylene diisocyanate (HDI), and isophorone diisocyanate (IPDI). Examples of the polyol include ethylene glycol, propylene glycol, glycerin, and hexanetriol. In the present invention, the isocyanate may also be a polymer with an increased molecular weight formed by the chain extension of a polyurethane polymer obtained by the reaction between a polyisocyanate and a polyol. In the present invention, one or more polyurethane resins may be used, and a mixture of a polyurethane resin and a polyvinyl acetal resin or an acrylic resin may also be used. A urethane-modified acrylic polymer may also be used as the polyurethane resin.

The polyurethane resin preferably has a Tg of −30 to 60° C., more preferably −20 to 40° C. When the polyurethane resin in the intermediate layer has a glass transition temperature Tg of 60° C. or lower, good adhesion can be obtained. In view of the stability of the polyurethane resin, the polyurethane resin in the intermediate layer preferably has a glass transition temperature Tg of −30° C. or higher.

The polyurethane resin for use in the present invention may be synthesized or obtained commercially. Examples of commercially available products include SUPERFLEX 150HS and SUPERFLEX 470 (all manufactured by DKS Co. Ltd.), HYDRAN (registered trademark) AP-20, HYDRAN (registered trademark) WLS-210, and HYDRAN (registered trademark) HW-161 (all manufactured by DIC Corporation), and Acrit 8UA series (manufactured by Taisei Fine Chemical Co., Ltd.).

A polyrotaxane structure-containing material may also be used as another material for the intermediate layer. Typical examples of such a material include SeRM Super Polymer A-1000 (hydroxy-containing polyrotaxane, manufactured by Advanced Soft Materials Inc.).

The intermediate layer preferably has a thickness of 1 μm to 10 μm, more preferably 4 μm to 10 μm, even more preferably 4 μm to 8 μm.

The intermediate layer preferably has a Young's modulus of 1.0×10⁻³ GPa to 2.0×10¹ GPa, more preferably 1.0×10⁻³ GPa to 1.0×10¹ GPa. When the Young's modulus is in these ranges, the intermediate layer can serve as a stress relaxing layer to relax the shrinkage stress on the hard coat layer, so that the intermediate layer can resist delamination even when there is a large volume shrinkage difference between the hard coat layer and the dielectric multilayer coating. The Young's modulus of the intermediate layer can be measured by the method described in the “Examples” section.

The derivative multilayer coating film of the present invention may have a single intermediate layer or two or more intermediate layers. Two or more intermediate layers may have the same or different compositions.

[5] Pressure-Sensitive Adhesive Layer

The dielectric multilayer coating film of the present invention may further include a pressure-sensitive adhesive layer. The pressure-sensitive adhesive used to form the pressure-sensitive adhesive layer is typically, but not limited to, an acrylic pressure-sensitive adhesive, a silicone-based pressure-sensitive adhesive, a urethane-based pressure-sensitive adhesive, a polyvinyl butyral-based pressure-sensitive adhesive, or an ethylene-vinyl acetate copolymer-based pressure-sensitive adhesive.

The dielectric multilayer coating film of the present invention can be bonded to a window glass. In view of re-bonding or re-alignment, the film of the present invention is preferably bonded to a window glass by a bonding technique, so-called a technique of pasting with water, which includes spraying water on the window and bonding the pressure-sensitive adhesive layer of the dielectric multilayer coating film to the wet glass surface. Therefore, an acrylic pressure-sensitive adhesive is preferably used, which has a relatively low adhesive strength under wet conditions with water present.

The acrylic pressure-sensitive adhesive to be used may be any of a solvent-based pressure-sensitive adhesive and an emulsion pressure-sensitive adhesive. A solvent-based pressure-sensitive adhesive is preferred because its adhesive strength can be easily increased. In particular, a solvent-based pressure-sensitive adhesive obtained by solution polymerization is preferred. When such a solvent-based acrylic pressure-sensitive adhesive is produced by solution polymerization, raw materials for the production of the adhesive may include, for example, a principal monomer for the skeleton, such as ethyl acrylate, butyl acrylate, 2-ethylhexylacrylate, octylacrylate, or other acrylic esters, a comonomer for improving cohesive strength, such as vinyl acetate, acrylonitrile, styrene, or methyl methacrylate, and a functional group-containing monomer for facilitating crosslinking, providing stable adhesive strength, and keeping a certain level of adhesive strength even in the presence of water, such as methacrylic acid, acrylic acid, itaconic acid, hydroxyethyl methacrylate, or glycidyl methacrylate. The main polymer for the pressure-sensitive adhesive layer of the multilayer film is particularly required to have high tackiness. Therefore, a low glass transition temperature (Tg) polymer such as polybutyl acrylate is particularly useful for the pressure-sensitive adhesive layer of the multilayer film.

The pressure-sensitive adhesive layer may also contain an additive such as a stabilizer, a surfactant, an ultraviolet absorber, a flame retardant, an antistatic agent, an antioxidant, a thermal stabilizer, a lubricant, a filler, a colorant, or an adhesion modifier. Particularly when the pressure-sensitive adhesive layer is for use on windows, the addition of an ultraviolet absorber is also effective to prevent ultraviolet-induced degradation of the derivative multilayer coating film.

The pressure-sensitive adhesive layer preferably has a thickness of 1 μm to 100 μm, more preferably 3 to 50 μm. When the thickness is 1 μm or more, the adhesion tends to increase, and sufficient adhesive strength can be obtained. On the other hand, when the thickness is 100 μm or less, the dielectric multilayer coating film can not only have improved transparency but also be prevented from causing the pressure-sensitive adhesive layer to undergo cohesive failure when the film is bonded to a window glass and then peeled off, which will tend to eliminate the occurrence of adhesive deposit on the glass surface.

[6] Other Functional Layers

Besides the layers described above, the dielectric multilayer coating film of the present invention may further have an additional functional layer such as a heat insulating layer as long as the objects and effects of the present invention are not compromised.

An adhesive layer may also be provided on at least one surface of the dielectric multilayer coating film of the present invention so that the film can be attached to a building component, a window glass, or the like.

As a non-limiting example, a dry laminate material, a wet laminate material, a heat seal material, a hog melt material, or the like may be used to form the adhesive layer for use in the present invention. The adhesive may include, for example, polyester resin, polyurethane resin, polyvinyl acetate resin, acrylic resin, or nitrile rubber.

The adhesive layer is preferably formed by a lamination process. Preferably, for example, such a process is continuously performed using a roll system in view of economy and productivity.

In general, the adhesive layer preferably has a thickness in the range of about 1 to about 100 μm in view of adhesive effect and drying rate.

<<Curl>>

The dielectric multilayer coating film of the present invention is preferably such that the reciprocal of the radius (units: m) of curvature of its curl in its widthwise direction is 0 to 30, more preferably 0 to 25, when it is measured under the conditions of a temperature of 23° C. and a humidity of 55% RH. Within these ranges, stress on the whole of the dielectric multilayer coating film can be kept low, and the weather-resistant adhesion can be further improved.

More specifically, the radius of curvature of the curl in the widthwise direction can be measured by the method described in the Examples section. If the measured radius of curvature of the curl is 0, the reciprocal will be assumed to be 0.

<<Fields of Applications of the Dielectric Multilayer Coating Film>>

The dielectric multilayer coating film of the present invention has the function of reflecting (blocking) sunlight, infrared light, visible light, or ultraviolet light. In particular, the derivative laminate coating film of the present invention is advantageously used as an infrared blocking film or an ultraviolet blocking film.

When the dielectric multilayer coating film has the structure shown in FIG. 1, an additional dielectric multilayer coating may be formed on the surface of the substrate 1 opposite to its surface on which the dielectric multilayer coating 4A and other components are provided. Subsequently, a transparent pressure-sensitive adhesive layer may be formed on the surface of the additional coating, and a transparent substrate such as a glass substrate may be attached to the pressure-sensitive adhesive layer on the additional coating to form a dielectric multilayer coating unit. Thus, the dielectric multilayer coating film can be fixed by bonding the surface of its pressure-sensitive adhesive layer to a boundary part between the outdoors and the indoors, such as an indoor surface of a window glass.

In other fields of applications, the dielectric multilayer coating film may be used as a component of a glass laminate. In this case, for example, an adhesive layer may be formed on each of the hard coat layers 6A and 6B of the dielectric multilayer coating film shown in FIG. 2, and glass substrates may be bonded with the adhesive layers to both sides of the dielectric multilayer coating film, so that a glass laminate can be obtained.

### EXAMPLES

Hereinafter, the present invention will be more specifically described with reference to examples, which, however, are not intended to limit the present invention.

[Preparation of Dielectric Multilayer Coating Film 1]

(Preparation of Low Refractive Index Layer-Forming Coating Liquid L1)

The materials shown below were sequentially mixed at 45° C.

Colloidal silica (SNOWTEX (registered trademark) OXS manufactured by Nissan Chemical Industries, Ltd., 10% by mass): 430 parts by mass

Aqueous boric acid solution (3% by mass): 150 parts by mass

Water: 85 parts by mass

Polyvinyl alcohol (JP-45 manufactured by JAPAN VAM & POVAL CO., LTD., 4% by mass, degree of polymerization 4,500, degree of saponification 88 mol %): 300 parts by mass

Surfactant (SOFTAZOLINE (registered trademark) LSB-R manufactured by Kawaken Fine Chemicals Co., Ltd., 5% by mass): 3 parts by mass

Finally, the mixture was diluted with pure water to 1,000 parts by mass, resulting in low refractive index layer-forming coating liquid L1.

(Preparation of High Refractive Index Layer-Forming Coating Liquid H1)

(Preparation of aqueous titanium oxide sol dispersion) With stirring, 30 L (liters) of an aqueous sodium hydroxide solution (concentration 10 mol/L) was added to 10 L of a dispersion of titanium dioxide hydrate in water (TiO₂ concentration 100 g/L). The mixture was heated to 90° C. and aged for 5 hours, which was followed by neutralization with hydrochloric acid, filtration, and washing with water. The titanium dioxide hydrate used in this reaction (treatment) was a product obtained by thermal hydrolysis of an aqueous titanium sulfate solution according to a known technique.

The base-treated titanium compound was suspended in pure water in such a way that a TiO₂ concentration of 20 g/L was reached. With stirring, 0.4 mol % of citric acid was added to the suspension based on the amount of TiO₂ and heated. When a liquid temperature of 95° C. was reached, concentrated hydrochloric acid was so added that a hydrochloric acid concentration of 30 g/L was reached, and the mixture was stirred for 3 hours while the liquid temperature was maintained.

The pH and zeta potential of the resulting aqueous titanium oxide sol dispersion were measured to be 1.4 and +40 mV, respectively. As a result of particle size measurement with Zeta Sizer Nano manufactured by Malvern instruments Ltd., the volume average particle size was 35 nm, and the monodispersity was 16%.

One kg of pure water was added to 1 kg of the aqueous 20.0% by mass titanium oxide sol dispersion containing rutile-type titanium dioxide particles with a volume average particle size of 35 nm.

<Preparation of Aqueous Silicic Acid Solution>

An aqueous silicic acid solution with a SiO₂ concentration of 2.0% by mass was prepared.

<Preparation of Silica-Modified Titanium Oxide Particles>

Two kg of pure water was added to 0.5 kg of the resulting aqueous 10.0% by mass titanium oxide sol dispersion and then heated to 90° C. Subsequently, 1.3 kg of the aqueous 2.0% by mass silicic acid solution was gradually added to the mixture. The resulting dispersion was then heat-treated at 175° C. for 18 hours in an autoclave. The product was then concentrated to give an aqueous sol dispersion of 20% by mass silica-modified titanium oxide particles, which were composed of titanium oxide with the rutile-type structure and a SiO₂ coating layer. The silica-modified titanium oxide particles are a compound with photocatalytic activity.

<Preparation of High Refractive Index Layer-Forming Coating Liquid>

The materials shown below were sequentially mixed at 45° C.

Aqueous sol dispersion of silica-modified titanium oxide particles (20.0% by mass): 320 parts by mass

Aqueous citric acid solution (1.92% by mass): 120 parts by mass

Polyvinyl alcohol (PVA-103 manufactured by KURARAY CO., LTD., 10% by mass, degree of polymerization 300, degree of saponification 99 mol %): 20 parts by mass

Aqueous boric acid solution (3% by mass): 100 parts by mass

Polyvinyl alcohol (PVA-124 manufactured by KURARAY CO., LTD., 4% by mass, degree of polymerization 2,400, degree of saponification 88 mol %): 350 parts by mass

Surfactant (SOFTAZOLINE (registered trademark) LSB-R manufactured by Kawaken Fine Chemicals Co., Ltd., 5% by mass): 1 parts by mass

Finally, the mixture was diluted with pure water to 1,000 parts by mass, resulting in high refractive index layer-forming coating liquid H1.

(Preparation of Intermediate Layer-Forming Coating Liquid)

An intermediate layer-forming coating liquid was prepared by dissolving LR1730 (acrylic resin manufactured by MITSUBISHI RAYON CO., LTD.) at a concentration of 20% by mass in ethanol.

(Preparation of Hard Coat Layer-Forming Coating Liquid)

AZO (antimony-doped zinc oxide, CELNAX (registered trademark) CX-Z410K (trade name), manufactured by Nissan Chemical Industries, Ltd.) was used as an infrared absorber. HITALOID (registered trademark) 7975 (ultraviolet-curable acrylic acrylate resin manufactured by Hitachi Chemical Company, Ltd.) was used as an ultraviolet-curable resin. Methyl ethyl ketone as a solvent was added to these materials. To the mixture was further added 0.08% by mass of a fluorochemical surfactant (Ftargent 650A (trade name) manufactured by Neos Corporation), so that a hard coat layer-forming coating liquid was obtained with a total solid content of 40 parts by mass and an AZO content of 55% by mass based on the mass of the total solids.

(Preparation of Dielectric Multilayer Coating Film (Infrared Blocking Film))

(Formation of Dielectric Multilayer Coating (Infrared Blocking Layer))

A slide hopper coater capable of performing nine-layer coating (multilayer coating) was used. While being kept at 45° C., low refractive index layer-forming coating liquid L1 and high refractive index layer-forming coating liquid H1 prepared as described above were applied to a 50-μm-thick polyethylene terephthalate film (A4300 manufactured by Toyobo Co., Ltd., with each adhesion layers on both sides, 200 m long×210 mm wide, refractive index 1.58) as a substrate heated at 45° C. Coating liquids L1 and H1 were applied by simultaneous multilayer coating in such a way that high and low refractive index layers (9 layers in total) were alternately stacked with the lowermost and uppermost layers being the low refractive index layers and that each low refractive index layer and each high refractive index layer could have a dry thickness of 150 nm and a dry thickness of 130 nm, respectively. The identification of the mixed region (mixed layer) between the layers and the measurement (checking) of the layer thickness were performed by cutting the resulting dielectric multilayer coating (dielectric multilayer coating film sample) and measuring the contents of the high refractive index layer material (TiO₂) and the low refractive index layer material (SiO₂) in the cut section with an XPS surface analyzer. As a result, it was confirmed that each layer thickness mentioned above was ensured.

Immediately after the application, the coating was set by blowing 5° C. cold air on the coating. In this case, the time (setting time) taken for the surface to become completely non-sticky to fingers was 5 minutes.

After the setting was completed, the coating was dried by blowing 80° C. hot air to give a dielectric multilayer coating composed of 9 layers. The resulting structure is named dielectric multilayer coating A.

Subsequently, using the same process, dielectric multilayer coating B composed of 9 layers was formed on the surface of the polyethylene terephthalate film opposite to its surface on which dielectric multilayer coating A was formed.

The high and low refractive index layers formed as described above had refractive indices of 1.95 and 1.45, respectively.

(Formation of Intermediate Layer)

Subsequently, the intermediate layer-forming coating liquid was applied to dielectric multilayer coating A with a wire bar in such a way that the resulting layer could have a dry thickness of 6.0 μm. The coating liquid was then dried to form an intermediate layer.

(Formation of Hard Coat Layer)

The hard coat layer-forming coating liquid prepared as described above was applied to the intermediate layer (formed as described above) with a wire bar under such conditions that the resulting layer could have a dry thickness of 8.5 μm. The coating liquid was then dried in a drying section at a temperature of 90° C. Using an ultraviolet lamp with an irradiance of 100 mW/cm², the dried coating was then cured at a dose of 0.5 J/cm² to forma hard coat layer, so that dielectric multilayer coating film 1 was obtained. The hard coat layer had a refractive index of 1.59.

### Preparation of Dielectric Multilayer Coating Film 2

### Example 2

Dielectric multilayer coating film 2 was prepared as in Example 1, except that the AZO concentration of the hard coat layer-forming coating liquid was changed to 65% by mass based on the mass of the total solids and the hard coat layer was formed to have a dry thickness of 7.0 μm.

### Preparation of Dielectric Multilayer Coating Film 3

### Example 3

Dielectric multilayer coating film 3 was prepared as in Example 2, except that the AZO concentration of the hard coat layer-forming coating liquid was changed to 75% by mass based on the mass of the total solids and the hard coat layer was formed to have a dry thickness of 5.5 μm.

### Preparation of Dielectric Multilayer Coating Film 4

### Example 4

Dielectric multilayer coating film 4 was prepared as in Example 1, except that the resin component of the hard coat layer-forming coating liquid was changed from HITALOID (registered trademark) 7975 to SHIKO UV-7600B (ultraviolet-curable urethane acrylate resin manufactured by The Nippon Synthetic Chemical Industry Co., Ltd.), the AZO concentration was changed to 50% by mass based on the mass of the total solids, and the hard coat layer was formed to have a dry thickness of 9.2 μm.

### Preparation of Dielectric Multilayer Coating Film 5

### Example 5

Dielectric multilayer coating film 5 was prepared as in Example 4, except that the AZO concentration of the hard coat layer-forming coating liquid was changed to 55% by mass based on the mass of the total solids and the hard coat layer was formed to have a dry thickness of 8.5 μm.

### Preparation of Dielectric Multilayer Coating Film 6

### Example 6

Dielectric multilayer coating film 6 was prepared as in Example 5, except that the AZO concentration of the hard coat layer-forming coating liquid was changed to 65% by mass based on the mass of the total solids and the hard coat layer was formed to have a dry thickness of 7.0 μm.

### Preparation of Dielectric Multilayer Coating Film 7

### Example 7

Dielectric multilayer coating film 7 was prepared as in Example 6, except that the AZO concentration of the hard coat layer-forming coating liquid was changed to 75% by mass based on the mass of the total solids and the hard coat layer was formed to have a dry thickness of 6.0 μm.

### Preparation of Dielectric Multilayer Coating Film 8

### Example 8

Dielectric multilayer coating film 8 was prepared as in Example 7, except that the AZO concentration of the hard coat layer-forming coating liquid was changed to 80% by mass based on the mass of the total solids and the hard coat layer was formed to have a dry thickness of 5.5 μm.

### Preparation of Dielectric Multilayer Coating Film 9

### Example 9

Dielectric multilayer coating film 9 was prepared as in Example 6, except that the resin component of the hard coat layer-forming coating liquid was changed from SHIKO UV-7600B to SHIKO UV-7650B (ultraviolet-curable urethane acrylate resin manufactured by The Nippon Synthetic Chemical Industry Co., Ltd.).

### Preparation of Dielectric Multilayer Coating Film 10

### Example 10

Dielectric multilayer coating film 10 was prepared as in Example 9, except that the resin component of the hard coat layer-forming coating liquid was changed from SHIKO UV-7650B to ETERMER 2382 (pentaerythritol ethylene oxide-modified tetraacrylate manufactured by Eternal Chemical Co., Ltd.).

### Preparation of Dielectric Multilayer Coating Film 11

### Example 11

Dielectric multilayer coating film 11 was prepared as in Example 6, except that an ultraviolet absorber Tinuvin (registered trademark) 234 (manufactured by BASF) was added at 0.1% by mass to the hard coat layer-forming coating liquid based on the mass of the total solids in the hard coat layer.

### Preparation of Dielectric Multilayer Coating Film 12

### Example 12

Dielectric multilayer coating film 12 was prepared as in Example 11, except that the content of Tinuvin (registered trademark) 234 in the hard coat layer-forming coating liquid was changed to 1.5% by mass based on the mass of the total solids in the hard coat layer.

### Preparation of Dielectric Multilayer Coating Film 13

### Example 13

Dielectric multilayer coating film 13 was prepared as in Example 11, except that the content of Tinuvin (registered trademark) 234 in the hard coat layer-forming coating liquid was changed to 3.0% by mass based on the mass of the total solids in the hard coat layer.

### Preparation of Dielectric Multilayer Coating Film 14

### Example 14

Dielectric multilayer coating film 14 was prepared as in Example 11, except that the content of Tinuvin (registered trademark) 234 in the hard coat layer-forming coating liquid was changed to 3.5% by mass based on the mass of the total solids in the hard coat layer.

### Preparation of Dielectric Multilayer Coating Film 15

### Example 15

Dielectric multilayer coating film 15 was prepared as in Example 12, except that an antioxidant ADK STAB LA-52 (manufactured by ADEKA CORPORATION) was added at 0.1% by mass to the hard coat layer-forming coating liquid based on the mass of the total solids in the hard coat layer.

### Preparation of Dielectric Multilayer Coating Film 16

### Example 16

Dielectric multilayer coating film 16 was prepared as in Example 15, except that the content of LA-52 in the hard coat layer-forming coating liquid was changed to 1.5% by mass based on the mass of the total solids in the hard coat layer.

### Preparation of Dielectric Multilayer Coating Film 17

### Example 17

Dielectric multilayer coating film 17 was prepared as in Example 15, except that the content of LA-52 in the hard coat layer-forming coating liquid was changed to 3.0% by mass based on the mass of the total solids in the hard coat layer.

### Preparation of Dielectric Multilayer Coating Film 18

### Example 18

Dielectric multilayer coating film 18 was prepared as in Example 15, except that the content of LA-52 in the hard coat layer-forming coating liquid was changed to 3.5% by mass based on the mass of the total solids in the hard coat layer.

### Preparation of Dielectric Multilayer Coating Film 19

### Example 19

Dielectric multilayer coating film 19 was prepared as in Example 16, except that SeRM Super Polymer A-1000 (hydroxy-containing polyrotaxane, manufactured by Advanced Soft Materials Inc.) was further added at a solid concentration of 3% by mass to the intermediate layer-forming coating liquid.

### Preparation of Dielectric Multilayer Coating Film 20

### Example 20

Dielectric multilayer coating film 20 was prepared as in Example 16, except that SeRM Super Polymer A-1000 was further added at a solid concentration of 5% by mass to the intermediate layer-forming coating liquid.

### Preparation of Dielectric Multilayer Coating Film 21

### Example 21

Dielectric multilayer coating film 21 was prepared as in Example 16, except that a product obtained by diluting Acrit 8UA-301 (urethane-modified acrylic polymer, manufactured by Taisei Fine Chemical Co., Ltd.) with MEK (methyl ethyl ketone) to a solid content of 30% by mass was used instead of LR1730 to form the intermediate layer-forming coating liquid.

### Preparation of Dielectric Multilayer Coating Film 22

### Example 22

(Preparation of Dielectric Multilayer Coating Film (Ultraviolet Blocking Film))

(Formation of Dielectric Multilayer Coating (Ultraviolet Blocking Layer))

A dielectric multilayer coating was formed using the same coating process as in Example 1, except that the thickness of each low refractive index layer was changed to 50 nm and the thickness of each high refractive index layer was changed to 43 nm. Subsequently, a polysiloxane-based hard coat material BP-16N (manufactured by DOKEN CO., LTD.) was applied in such a way that a hard coat layer with a dry thickness of 3 μm could be formed. The product was then aged at 50° C. for 5 days to give dielectric multilayer coating film 22 with ultraviolet blocking properties.

### Comparative Examples

### Preparation of Dielectric Multilayer Coating Film 23

### Comparative Example 1

Dielectric multilayer coating film 23 was prepared as in Example 2, except that BEAMSET (registered trademark) 577 (urethane acrylate, manufactured by ARAKAWA CHEMICAL INDUSTRIES, LTD.) was used instead of HITALOID (registered trademark) 7975.

### Preparation of Dielectric Multilayer Coating Film 24

### Comparative Example 2

Dielectric multilayer coating film 24 was prepared as in Example 2, except that ARONIX (registered trademark) M305 (urethane acrylate, manufactured by TOAGOSEI CO., LTD.) was used instead of HITALOID (registered trademark) 7975.

### Preparation of Dielectric Multilayer Coating Film 25

### Comparative Example 3

Dielectric multilayer coating film 25 was prepared as in Comparative Example 2, except that DPHA (dipentaerythritol hexaacrylate, manufactured by Daicel-Cytec Company Ltd.) was used instead of ARONIX (registered trademark) M305.

### Preparation of Dielectric Multilayer Coating Film 26

### Comparative Example 4

Dielectric multilayer coating film 26 was prepared as in Comparative Example 2, except that HDDA (1,6-hexanediol diacrylate, manufactured by Daicel-Cytec Company Ltd.) was used instead of ARONIX (registered trademark) M305.

Table 1 below shows the composition of the dielectric multilayer coating film obtained in each of the examples and the comparative examples.

TABLE 1

| | Hard coat layer | | | | | |
|---|---|---|---|---|---|---|
| | | Infrared | Ultraviolet | | | Dielectric |
| | | absorber | absorber | Antioxidant | Intermediate | multilayer |
| | | content | content | content | layer | coating |
| | Type | (mass %) | (mass %) | (mass %) | Type | type |
| Example 1 | HITALOID | 55 | — | — | LR1730 | Infrared |
| | 7975 | | | | | blocking |
| Example 2 | ↑ | 65 | — | — | ↑ | ↑ |
| Example 3 | ↑ | 75 | — | — | ↑ | ↑ |
| Example 4 | UV-7600B | 50 | — | — | ↑ | ↑ |
| Example 5 | ↑ | 55 | — | — | ↑ | ↑ |
| Example 6 | ↑ | 65 | — | — | ↑ | ↑ |
| Example 7 | ↑ | 75 | — | — | ↑ | ↑ |
| Example 8 | ↑ | 80 | — | — | ↑ | ↑ |
| Example 9 | UV-7650B | 65 | — | — | ↑ | ↑ |
| Example 10 | ETERMER | 65 | — | — | ↑ | ↑ |
| | 2382 | | | | | |
| Example 11 | UV-7600B | ↑ | 0.1 | — | ↑ | ↑ |
| Example 12 | ↑ | ↑ | 1.5 | — | ↑ | ↑ |
| Example 13 | ↑ | ↑ | 3 | — | ↑ | ↑ |
| Example 14 | ↑ | ↑ | 3.5 | — | ↑ | ↑ |
| Example 15 | ↑ | ↑ | 1.5 | 0.1 | ↑ | ↑ |
| Example 16 | ↑ | ↑ | ↑ | 1.5 | ↑ | ↑ |
| Example 17 | ↑ | ↑ | ↑ | 3 | ↑ | ↑ |
| Example 18 | ↑ | ↑ | ↑ | 3.5 | ↑ | ↑ |
| Example 19 | ↑ | ↑ | ↑ | 1.5 | LR1730 + | ↑ |
| | | | | | A1000 3% | |
| Example 20 | ↑ | ↑ | ↑ | ↑ | LR1730 + | ↑ |
| | | | | | A1000 5% | |
| Example 21 | ↑ | ↑ | ↑ | ↑ | Acrit | ↑ |
| | | | | | 8UA-301 | |
| Example 22 | ↑ | — | — | — | LR1730 + | Ultraviolet |
| | | | | | A1000 3% | blocking |
| Comparative | BEAMSET 577 | 65 | — | — | LR1730 | Infrared |
| Example 1 | | | | | | blocking |
| Comparative | ARONIX M305 | ↑ | — | — | ↑ | ↑ |
| Example 2 | | | | | | |
| Comparative | DPHA | ↑ | — | — | ↑ | ↑ |
| Example 3 | | | | | | |
| Comparative | HDDA | ↑ | — | — | ↑ | ↑ |
| Example 4 | | | | | | |

<Measurement of Volume Shrinkage>

The volume shrinkage was measured by the following method. The specific gravity of the resin was measured according to JIS Z 8807:2012. Assuming that the density of water is 1 g/cm³, the measured value was used as the resin density (g/cm³) before curing.

The resin density after curing was determined by the following procedure. The high refractive index layer-forming coating liquid, the low refractive index layer-forming coating liquid, and the hard coat layer-forming coating liquid were each applied to a 50-μm-thick polyethylene terephthalate film. The high refractive index layer-forming coating liquid and the low refractive index layer-forming coating liquid were then each dried to forma coating. The hard coat layer-forming coating liquid was then irradiated with ultraviolet rays to forma coating. The weight (g), area (cm²), and thickness (μm) of each resulting coating were measured and then used in the calculation of the resin density (g/cm³) after curing. The volume shrinkage was calculated from the resin densities before and after curing using the following mathematical formula (1):

[Formula 3]

Volume shrinkage (%)=(the resin density before curing)/(the resin density after curing)×100 (1)

The volume shrinkage of the half of the dielectric multilayer coating distal to the hard coat layer was determined as follows. The volume shrinkage of each high refractive index layer and that of each low refractive index layer were determined by the method described above. The weight and volume of the five-layer part (three low refractive index layers and two high refractive index layers) of dielectric multilayer coating A were determined. The volume shrinkage of the five-layer part was calculated from the determined weight and volume and the volume shrinkage of each layer. In order to determine the volume shrinkage after the heat deterioration treatment, the weight and volume of each single layer were measured after the weather resistance test, and the density was determined therefrom.

A difference was calculated between the volume shrinkages of the dielectric multilayer coating and the hard coat layer determined as described above.

<Young's Modulus of Intermediate Layer>

The Young's modulus of the intermediate layer was measured as follows. The experimental force (load)-indentation depth curve of the surface of the intermediate layer was measured in the dielectric multilayer coating film obtained before the hard coat layer was formed. The Poisson's ratio was measured using a single film of the intermediate layer prepared separately. The single film of the intermediate layer was formed by applying the intermediate layer-forming solution to a glass sheet with an applicator and then drying the solution at 100° C. for 3 minutes. The experimental force (load)-indentation depth curve was measured with Shimadzu Dynamic Ultra-Micro Hardness Tester DUH-211S manufactured by SHIMADZU CORPORATION, and the Poisson's ratio was measured with Tensilon RTA-100 manufactured by ORIENTEC Co., Ltd. The Young's modulus was calculated from the experimental force (load)-indentation depth curve and the Poisson's ratio.

<Measurement of Curl>

The curl of the dielectric multilayer coating film was measured using the curl measurement template for method A provided in “Determination of the Curl of Photographic Film” according to JIS K 7619:1988. In this regard, “positive curl” refers to the curl of the film with the hard coat layer side curved inward, and “negative curl” refers to the curl of the film with the hard coat layer side curved outward. The curl is expressed by the following mathematical formula A.

[Formula 4]

Curl=1/R (R is the radius of curvature (units: m)) (A)

<<Preparation of Dielectric Multilayer Coating Unit>>

(Formation of Adhesive Layer and Bonding to Glass Substrate)

A 10-μm-thick pressure-sensitive adhesive layer of polyvinyl butyral containing 5% of Tinuvin (registered trademark) 477 was formed on dielectric multilayer coating B of each of dielectric multilayer coating films 1 to 26 prepared as described above. A 3-mm-thick clear glass sheet was then placed on the pressure-sensitive adhesive layer. After the excess part squeezed out of the edge of the glass sheet was removed, the stacked materials were bonded together by heating at 140° C. for 30 minutes, pressurization, and deaeration, so that derivative multilayer coating units 1 to 26 were obtained.

<<Evaluation of Dielectric Multilayer Coating Units>>

Dielectric multilayer coating units 1 to 26 prepared as described above were subjected to each evaluation process described below.

[Measurement of Hardness]

The surface of the hard coat layer of the dielectric multilayer coating unit was rubbed with #0000 steel wool moving back and forth 10 times with a stroke of 100 mm and a rate of 30 mm/second under a load of 500 g/cm². The number of scratches on the surface was then counted and ranked according to the following criteria.

5: no scratches

4: 1 to 10 scratches

3: 11 to 30 scratches

2: 31 to 50 scratches

1: 51 or more scratches

[Evaluation of Weather-Resistant Adhesion]

Dielectric multilayer coating units 1 to 26 prepared as described above were evaluated for weather-resistant adhesion by the method described below.

<Accelerated Deterioration Treatment>

Each dielectric multilayer coating unit was subjected to an accelerated deterioration treatment using Sunshine Weather Meter (S80HB manufactured by Suga Test Instruments Co., Ltd.), in which the glass side of the unit was placed on the light source side, and the unit was continuously irradiated with light at an irradiance of 255 W/m² (300 to 700 nm) for 2,000 hours in an environment at a temperature of 40° C. and a humidity of 50% RH.

<Evaluation of Adhesion>

Immediately after the preparation (initial stage) and after the accelerated deterioration treatment, each dielectric multilayer coating unit was evaluated for adhesion by the method described below.

The adhesion between the components of each dielectric multilayer coating unit was evaluated by the cross-cut test according to JIS K 5600-5-6 (2004).

Using a cutter knife and cutter guides at intervals of 1 mm, 100 cross-cuts of 1 mm×1 mm were formed in the hard coat layer side of the dielectric multilayer coating unit so as to reach the substrate. A pressure-sensitive adhesive cellophane tape (CT405AP-18 manufactured by Nichiban Co., Ltd., 18 mm wide) was attached to the incised surface. The top of the tape was rubbed with an eraser so that the tape was completely bonded. Subsequently, the tape was detached by pulling it in the vertical direction, and it was counted how many parts of the dielectric multilayer coating film remained on the substrate surface out of the 100 squares.

Table 2 below show the results of the evaluation.

TABLE 2

| | | | Adhesion after | | Young's | |
|---|---|---|---|---|---|---|
| | Difference | Initial | weather | | modulus | |
| | (%) between | adhesion | resistance test | | (GPa) of | |
| | volume | (remaining | (remaining | Hardness | intermediate | Curl |
| | shrinkages | parts/100) | parts/100) | (rank) | layer | (1/R) |
| Example 1 | 8 | 100 | 29 | 5 | 1.5 | 22 |
| Example 2 | 7.7 | 100 | 41 | 5 | 1.5 | 20 |
| Example 3 | 7.2 | 100 | 55 | 5 | 1.5 | 18 |
| Example 4 | 7.1 | 100 | 50 | 5 | 1.5 | 34 |
| Example 5 | 6.1 | 100 | 55 | 5 | 1.5 | 28 |
| Example 6 | 5.6 | 100 | 62 | 5 | 1.5 | 20 |
| Example 7 | 4.9 | 100 | 69 | 5 | 1.5 | 16 |
| Example 8 | 3 | 100 | 78 | 3 | 1.5 | 14 |
| Example 9 | 5.6 | 100 | 92 | 3 | 1.5 | 18 |
| Example 10 | 1.1 | 100 | 100 | 3 | 1.5 | 10 |
| Example 11 | 5.6 | 100 | 70 | 5 | 1.5 | 20 |
| Example 12 | 5.6 | 100 | 71 | 5 | 1.5 | 20 |
| Example 13 | 5.6 | 100 | 79 | 5 | 1.5 | 20 |
| Example 14 | 5.6 | 100 | 80 | 4 | 1.5 | 20 |
| Example 15 | 5.6 | 100 | 84 | 5 | 1.5 | 20 |
| Example 16 | 5.6 | 100 | 93 | 5 | 1.5 | 20 |
| Example 17 | 5.6 | 100 | 96 | 5 | 1.5 | 20 |
| Example 18 | 5.6 | 100 | 96 | 4 | 1.5 | 20 |
| Example 19 | 5.6 | 100 | 100 | 5 | 0.2 | 18 |
| Example 20 | 5.6 | 100 | 100 | 5 | 0.08 | 16 |
| Example 21 | 5.6 | 100 | 100 | 5 | 0.4 | 18 |
| Example 22 | 5.6 | 100 | 100 | 5 | 0.2 | 18 |
| Comparative | 10.6 | 100 | 0 | 5 | 1.5 | 42 |
| Example 1 | | | | | | |
| Comparative | 10.2 | 100 | 0 | 5 | 1.5 | 40 |
| Example 2 | | | | | | |
| Comparative | 14.5 | 100 | 0 | 5 | 1.5 | 58 |
| Example 3 | | | | | | |
| Comparative | 0.05 | 100 | 100 | 1 | 1.5 | 4 |
| Example 4 | | | | | | |

After the heat deterioration treatment, the five-layer part of the dielectric multilayer coating has a volume shrinkage of 1.3%. The volume shrinkage of the hard coat layer of each of dielectric multilayer coating films 1 to 26 was measured and used to calculate the difference from the volume shrinkage of the dielectric multilayer coating. A comparison between the differences in volume shrinkage and a comparison between the results on weather-resistant adhesion show that the dielectric multilayer coating films of the examples with a volume shrinkage difference in the range according the present invention have improved weather-resistant adhesion. This relationship is also correlated with the degree of the curl. As the curl decreases, the weather-resistant adhesion increases. Dielectric multilayer coating films with a curl value of 30 or less can have good weather-resistant adhesion. It has also been found that the addition of an ultraviolet absorber and/or an antioxidant can further increase the weather-resistant adhesion. It has also been found that the use of a low-Young's modulus resin in the intermediate layer can increase the weather-resistant adhesion. In other words, it has been shown that making the hard coat layer less shrinkable, adding an ultraviolet absorber and/or an antioxidant, and reducing the Young's modulus of the intermediate layer can significantly increase the weather-resistant adhesion. It has also been found that when the volume shrinkage difference falls within the range according to the present invention, even ultraviolet-blocking dielectric multilayer coating films can also have improved weather-resistant adhesion.

In contrast, it is apparent that the dielectric multilayer coating films of Comparative Examples 1 to 3 have significantly lower weather-resistant adhesion because they are produced using a hard coat layer with a larger volume shrinkage. The hard coat layer of the dielectric multilayer coating film of Comparative Example 4 has significantly lower scratch resistance.

Thus, it has been demonstrated that the dielectric multilayer coating film of the present invention has significantly improved weather-resistant adhesion, and the present invention makes it possible to form excellent dielectric multilayer coatings.

The present application claims the benefit of priority to Japanese Patent Application No. 2013-125800 filed on Jun. 14, 2013, the disclosure of which is incorporated herein by reference in its entirety.

1. A dielectric multilayer coating film, comprising:
a dielectric multilayer coating having a stack of high and low refractive index layers; and
a hard coat layer, wherein
at least one of the high and low refractive index layers contains a compound with photocatalytic activity, and
when the dielectric multilayer coating is divided into two halves along its thickness direction, there is a difference of 0.1% to less than 10% between the volume shrinkage of the half distal to the hard coat layer and the volume shrinkage of the hard coat layer.

2. The dielectric multilayer coating film according to claim 1, wherein when the dielectric multilayer coating is divided into two halves along its thickness direction, there is a difference of 1% to 7% between the volume shrinkage of the half distal to the hard coat layer and the volume shrinkage of the hard coat layer.

3. The dielectric multilayer coating film according to claim 1, further comprising an intermediate layer with a Young's modulus of 1.0×10⁻³ GPa to 2.0×10¹ GPa between the dielectric multilayer coating and the hard coat layer.

4. The dielectric multilayer coating film according to claim 1, which is such that the reciprocal of the radius (in units of m) of curvature of its curl in its widthwise direction is 0 to 30 when it is measured under conditions of a temperature of 23° C. and a humidity of 55% RH.

5. The dielectric multilayer coating film according to claim 1, wherein the hard coat layer further contains an ultraviolet absorber.

6. The dielectric multilayer coating film according to claim 5, wherein the content of the ultraviolet absorber is 0.1% by mass to 3% by mass based on the total mass of the hard coat layer.

7. The dielectric multilayer coating film according to claim 1, wherein the hard coat layer further contains an antioxidant.

8. The dielectric multilayer coating film according to claim 7, wherein the content of the antioxidant is 0.1% by mass to 3% by mass based on the total mass of the hard coat layer.

9. The dielectric multilayer coating film according to claim 1, which is an infrared blocking film.

10. The dielectric multilayer coating film according to claim 9, wherein the hard coat layer further contains an infrared absorber, and the content of the infrared absorber is 55% by mass to 80% by mass based on the total mass of the hard coat layer.

11. The dielectric multilayer coating film according to claim 1, which is an ultraviolet blocking film.

12. The dielectric multilayer coating film according to claim 1, wherein the dielectric multilayer coating and the hard coat layer are provided on at least one surface of a substrate.

13. A glass laminate comprising the dielectric multilayer coating film according to claim 1.

14. The dielectric multilayer coating film according to claim 2, further comprising an intermediate layer with a Young's modulus of 1.0×10⁻³ GPa to 2.0×10¹ GPa between the dielectric multilayer coating and the hard coat layer.

15. The dielectric multilayer coating film according to claim 2, which is such that the reciprocal of the radius (in units of m) of curvature of its curl in its widthwise direction is 0 to 30 when it is measured under conditions of a temperature of 23° C. and a humidity of 55% RH.

16. The dielectric multilayer coating film according to claim 2, wherein the hard coat layer further contains an ultraviolet absorber.

17. The dielectric multilayer coating film according to claim 2, wherein the hard coat layer further contains an antioxidant.

18. The dielectric multilayer coating film according to claim 2, which is an infrared blocking film.

19. The dielectric multilayer coating film according to claim 2, which is an ultraviolet blocking film.

20. The dielectric multilayer coating film according to claim 2, wherein the dielectric multilayer coating and the hard coat layer are provided on at least one surface of a substrate.
